(19) United States
(12) Patent Application Publication
(10) Pub. No.: US 2023/0274081 A1
(43) Pub. Date: Aug. 31, 2023

(54) SYSTEMS AND METHODS FOR ANNOTATING LINE CHARTS IN THE WILD

(71) Applicants: Arlen Fan, Phoenix, AZ (US); Yuxin Ma, Shenzhen (CN); Ross Maciejewski, Phoenix, AZ (US)

(72) Inventors: Arlen Fan, Phoenix, AZ (US); Yuxin Ma, Shenzhen (CN); Ross Maciejewski, Phoenix, AZ (US)

(73) Assignee: Arizona Board of Regents on behalf of Arizona State University, Tempe, AZ (US)

(21) Appl. No.: 18/106,926

(22) Filed: Feb. 7, 2023

Related U.S. Application Data
(60) Provisional application No. 63/307,395, filed on Feb. 7, 2022.

(51) Int. Cl. G06F 40/169; G06V 30/14; G06V 30/19; G06F 40/30

(52) U.S. Cl. CPC G06F 40/169; G06V 30/1444; G06V 30/19173; G06F 40/30

(57) ABSTRACT

The present disclosure describes examples of a computer-implemented framework that helps to detect deception in charts and/or associated articles through textual and visual annotations.

### CROSS REFERENCE TO RELATED APPLICATIONS

This is a non-provisional application that claims benefit to U.S. Provisional Application Ser. No. 63/307,395, filed on Feb. 7, 2022, which is herein incorporated by reference in its entirety.

### GOVERNMENT SUPPORT

This invention was made with government support under 2017-ST-061-000101 awarded by the Department of Homeland Security, Science and Technology. The government has certain rights in the invention.

### FIELD

The present disclosure generally relates to fact checking in visual aids, and in particular, to a system and associated method for detecting, annotating, and revising potential deceptive and biased designs in line charts.

### BACKGROUND

Charts and data graphics have been widely used for communicating dense amounts of numerical information and are a preferred way to view data in many types of documents. Charts can be found in all mass news sources, from television channels to periodicals and are used to assist in storytelling. Such visualizations have become increasingly popular due to the development of easy-to-access tools for creating them, such as Plotly, Microsoft Excel, and Tableau. However, the increased ease of visualization construction brings new challenges. Ideally, designers who craft visualizations are considered to be objective, unbiased, and immune to deliberate manipulations. They are responsible for following guidelines to convey succinct information and tell stories concisely, responsibly, and accurately. However, there have been many cases where chart designers violate key design principles and alter the reader's understanding of the graph, whether knowingly or unknowingly. Typical examples include truncated y-axes where the vertical graph baseline does not start at zero, unnecessary 3-D representations to distort the sizes or angles of the visual elements, and arbitrary visual encodings that do not reflect data values.

Besides visual components in charts, misaligned titles and verbal comments also create barriers for chart comprehension. Intentionally selected, miscued, or contradictory descriptions in the charts have been shown to harm the credibility of the data sources. Such problems could result in degraded readability and misinterpretation of the data being represented in a chart. Furthermore, designers with wicked goals could exploit the false designs as “attack vectors” to control how the audience perceive patterns and trends in datasets, leading to biased understandings and misinformation cascades. Ideally, deceptive tactics, whether intentional or accidental, should be addressed and avoided in the design stage. Yet, deceptive visualizations are still commonplace, and while tools have been developed to help identify potential deceptive practices during the visualization design phase, such linting and annotation practices also need to be made available to general knowledge consumers to help improve visualization literacy and increase critical thinking when reading charts. As such, there is a need for effective tools to alert visualization consumers to potentially erroneous design practices.

It is with these observations in mind, among others, that various aspects of the present disclosure were conceived and developed.

### BRIEF DESCRIPTION OF THE DRAWINGS

FIGS. 1A-1D are a series of graphical representations showing a fictional dataset used to illustrate the effects of truncating the y-axis such that FIGS. 1A and 1B show the same data only except the aspect ratio is heavily distorted and such that FIGS. 1C and 1D also show the same data, with FIG. 1C using a truncated axis and FIG. 1D using a zero baseline;

FIG. 2A is a data flow diagram showing a process of a framework for detecting, annotating, and revising potential deceptive and biased designs in line charts;

FIG. 2B is an example system diagram supporting the data flow of FIG. 2A;

FIG. 2C is an example process flow associated with the system of FIG. 2B;

FIG. 3 are a series of a graphical representations showing a web interface of the framework of FIG. 2;

FIG. 4 is a graphical representation showing a first line chart for analysis featuring a corrected visualization based on water levels in Lake Mead;

FIG. 5 is a graphical representation showing a second line chart for analysis featuring a corrected visualization based on gun deaths in Florida;

FIG. 6 is a graphical representation showing a third line chart for analysis featuring a corrected visualization based on sunspots observed per year;

FIG. 7 is a graphical representation showing an experimental design setup for testing efficacy of the framework of FIG. 2;

FIG. 8 is a graphical representation showing test results for differences in Message Exaggeration deception with and without aid from the framework of FIG. 2;

FIG. 9 is a graphical representation showing 95% confidence intervals of the odds ratios for both Message Exaggeration (Group 1 vs 2) and Message Reversal (Group 3 vs 4) experiments;

FIG. 10A is an example system diagram supporting a second framework for 1001 described herein;

FIG. 10B is an example process associated with the system of FIG. 10A;

FIG. 11 is an illustration of an interface associated with a second example of a framework for news annotation using similar methods described herein;

FIG. 12 is an illustration of an end-to-end pipeline associated with the second example of a framework described herein that links text content with the data;

FIG. 13 is an illustration of sample output associated with the second framework example described herein;

FIG. 14 is an illustration of stages of an experiment associated with the second framework described herein;

FIGS. 15A-15B are (inaccurate/misleading) graphs referenced as part of a justification and example of the second framework described herein;

FIG. 16 illustrates log scale plotting confidence intervals of the odds ratios as described herein;

FIG. 17 is a simplified diagram showing an exemplary computing device that can be used as part of an implementation of the system of FIG. 1 and/or FIG. 11.

Corresponding reference characters indicate corresponding elements among the view of the drawings. The headings used in the figures do not limit the scope of the claims.

### DETAILED DESCRIPTION

While numerous visualizations have been developed, recent research has established that line charts are the most prevalent type of visualization found in the wild, with studies indicating upwards of 35% of charts found in the wild are some variation of the line chart. Given the overwhelming prevalence of line charts and its variants, a framework for annotating potentially deceptive line charts in the wild is presented herein. The present framework, which can be implemented by a system as described herein, is inspired by the initial attempts to reverse-engineer existing chart images. Based on the extraction of critical visual elements, an interactive approach to detect and annotate potentially deceptive and biased designs is conducted in a semi-automatic way under existing theoretical guidelines.

There is no specific target group for the present framework and is intended to be used by all people, regardless of previous data visualization experience. To cater to the needs of a lay audience, the present framework 100 is intended to be consumer-friendly, highly-automated, and easily accessible. The present framework has the ability to extract the specifications and data of a chart and return annotations that effectively point out exactly where there are potentially deceptive elements. It also outputs what an ideal re-construction of the graph could look like if the potentially deceptive practices were removed. Case studies are presented to show how the framework handles various methods of deceptive chart construction techniques. A crowdsourced experiment is then conducted to gauge the usefulness of the framework on a lay audience. Results suggest that the tool affects the visualization consumer's response in the intended manner. That is, for message exaggerated charts, subjects who used the framework were more likely to provide a lower category response; and for message inverted charts, subjects who used the framework were more likely to provide the correct response over an incorrect one. Finally, a tool like this is much needed, as people with similar data visualization abilities are still greatly affected by deceptive visualizations. Given the amount of potentially deceptive line charts in the wild, it is believed that the framework is a valuable educational tool that can be used to enhance basic visual literacy.

### Introduction

### Graphical Perception:

Prior research has investigated how visual encodings such as position, length, and color affect how a viewer perceives information in visualizations. Bertin was one of the first to pioneer this concept. Since then, numerous researchers have ranked the effectiveness of different types of visual encodings. A well-known Cleveland and McGill experiment suggests that position along a common scale leads to the most accurate comparisons on quantitative data, while volume and color encodings lead to less accurate ones. In line charts, aspect ratio is responsible for altering the viewer's response to how much change has occurred. Steeper angles overemphasize the change particularly when the data has shown little change.

Designers can find a way to take advantage of the tenets of graphical perception and create visualization distortions that can be categorized as “obfuscations” and “nudges.” In an obfuscation attack, the visual encodings are designed in such a way that makes extraction and interpretation extremely difficult. The immediate effect is that readers are unable to read information, but it is possible to make people less confident in the data or their own understanding of the data. Brewer shows how using poor colors in maps can cause them to be hard to read. For example, using colors that are too similar makes them indistinguishable from others. Nudges are a more subtle form of attack that leverages design principles and human psychology to encourage a certain takeaway message. For example, red glyphs in choropleths are perceived as having greater area than the green glyphs. In scatterplots and parallel coordinates, people generally overestimate negative correlations and underestimate positive correlations in both types of charts. All of these points are important considerations for graph designers, as they ultimately affect the message conveyed.

### Distortion Techniques:

Although distortions and deceptive charts have existed for a long time, Pandey et al. was among the first to define and categorize deceptive data visualizations. They classify deceptive visualizations into two types: message exaggeration/understatement and message reversal. Message exaggeration manipulates the extent a value has changed. This will affect “how much” a reader thinks a value is changing. Message reversal leads the reader to have the opposite takeaway of what the data is actually conveying. This will affect “what” has happened in the context of the graph.

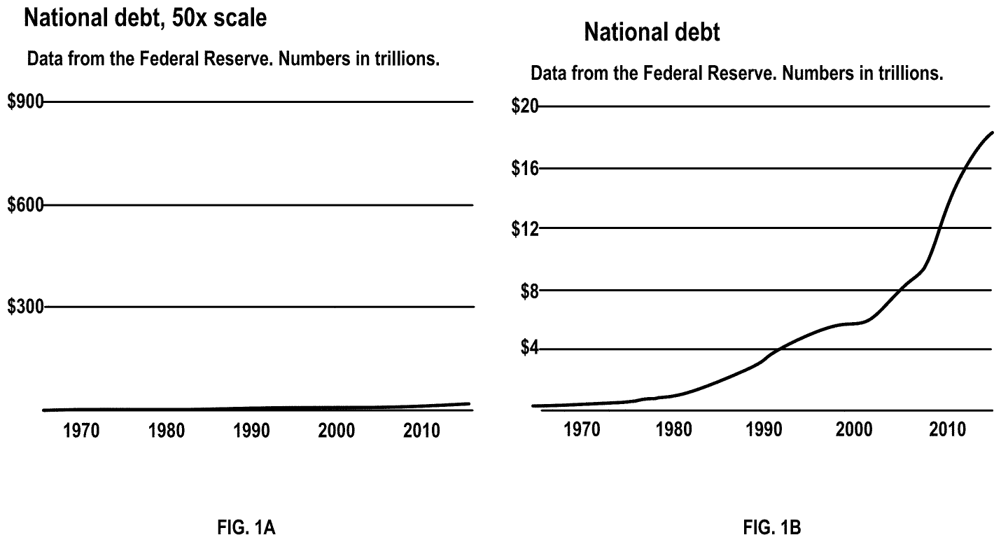

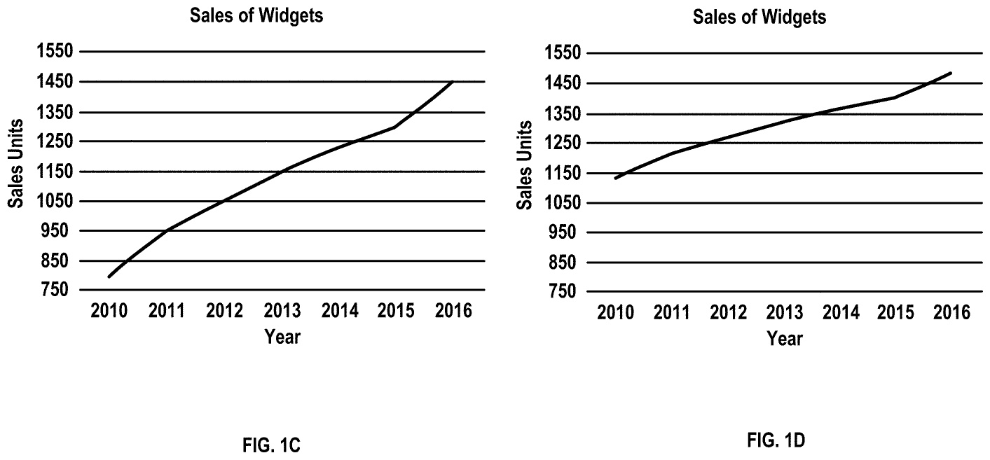

Changing the aspect ratio of a chart is a popular distortion technique with line charts. By selecting a large aspect ratio, the graph can appear to be oblong, and all of the angles of the segments are de-emphasized. This gives the impression that there is less change in the graph than there actually is (see FIG. 1A versus FIG. 1B). Conversely, selecting a small aspect ratio causes the graph to be compressed, effectively exaggerating its effect size. This technique leads to the message exaggeration/understatement type of deception.

Truncating the y-axis is another popular distortion technique. Starting the y-axis baseline at a nonzero value can create the impression of an important change in value, when there is relatively little change (see FIG. 1C versus FIG. 1D). This technique also leads to the message exaggeration type of deception.

Finally, y-axis inversion is a technique that can be employed on multiple types of charts. Inverting the numbers on the vertical scale defies conventions that people are used to. For example, the up direction is expected to signify an increase, and the down direction a decrease. However, in an inverted y-axis graph, these conventions are reversed, which lends itself to being extremely deceptive to careless, hasty, or inexperienced chart readers. This leads to the message reversal type of deception.

### Graph Comprehension:

All of these different deception mechanisms rely on the readers ability to comprehend the underlying charts and data. However, the ability to comprehend graphs is non-universal, and there exists a whole spectrum of skill levels in between unfamiliarity and mastery. Graph comprehension is defined as the ability to read and understand a graph. Many researchers have reached a consensus on dividing graph comprehension into three levels for a universal framework: 1) elementary level in which a graph reader can read simple values (e.g. reading the value of a point in a Cartesian coordinate plane); 2) intermediate level in which a graph reader can understand trends and relationships (e.g. deducing positive and negative slopes in line charts); and 3) advanced level in which a reader can read what is not explicitly stated in the graph (e.g. predicting trends based on past data). However, Lee et al. argued that this framework was too simplistic and developed the Visual Literacy Assessment Test (VLAT), a tool used for assessing a person's visual ability across many chart types.

Part of the challenge with graph comprehension and visual literacy is that a great deal of information in data visualization is communicated indirectly via the conventions of the design medium. For example, if readers see a pie chart, then they will expect that the information being presented are parts of a whole (e.g., the values add up to 100%). Such a chart becomes erroneous or confusing if the values do not add up to 100%. If readers see a line chart with an increasing trend, they expect the underlying value to be growing. However, if the chart is constructed with an inverted y-axis, the truth is actually the opposite. Deceptive visualizations arise when designers break with the expected design convention norms. A graph can be semantically correct, but if people make quick assumptions about the graph, key components can be easily overlooked, leading to potential deception.

Textual information is also incorporated into graphs to assist in graph comprehension. However, recent studies suggest that text captions are not effective in overcoming misleading visualization designs. Lauer and O'Brien found that people fall victim to deceptive charts regardless of accurate text explanations. Kim et al. found that readers more often rely on high-prominence chart features more so than text captions to draw final conclusions. In some cases, readers completely ignore the caption and rely solely on the chart to seek information. Given the tendency of readers to be drawn to visuals, the framework reconstructs the graph, and overlays both visual and textual annotations to highlight deceptive chart constructions.

### Annotating Line Charts in the Wild

### Motivation

With the widespread use of deceptive visualizations, effective tools to identify potential deception must be created to help combat the spread of misinformation. Line charts are the most common type of charts found in the Web. As such, the framework supports the annotation of potentially deceptive line charts. The process of annotating design flaws in charts has recently been given the name “linting,” inspired by the static code analysis tool intended to flag bugs and programming errors. Current linting tools for deceptive visualization do exist, for example, VisuaLint, a tool that uses textual and visual cues to alert designers to a potential Vega-Lite chart construction errors. McNutt and Kindlmann devise a set of rules and check Matplotlib charts against those rules. VizLinter takes an incorrect Vega-Lite specification and employs a fixer engine to detect and correct chart construction flaws. However, these tools are limited in scope in that they only support Vega-Lite or Matplotlib, which require specialized knowledge of its syntax and grammar. Most visualizations on the Web were not created in this software nor do they come with the corresponding source files. To reach a broader audience, the ideas of linting and annotation functionality are extended to support identifying potentially deceptive line chart images in the wild.

The latest advances in computer vision have made it possible to read charts with little to no human intervention. A chart can be reverse-engineered by recovering its specifications, which is information about the axes and labels. This is done by using optical character recognition (OCR) to extract text along with their positions. A machine learning model classifies the role (e.g. y-axis-label, x-axis-label) of the text. A neural net is then used to classify the type of chart (i.e. line, bar, area). The text and their positions, along with the chart type forms a complete specification; an identical bare chart can be reconstructed with this minimal set of information. The next step in the process is to extract the data from the line chart.

The present invention uses a full end-to-end solution WebPlotDigitizer to read the data. This tool uses affine transformations to map locations on the chart to datapoints with a human-defined calibration.

### Guidelines for Building Line Charts

Obtaining the chart information is the first step of the framework 100. Then, principles and guidelines for building and correcting line charts can be applied and evaluated with respect to the extracted chart and data. Based on a review of line chart literature, several key guidelines are identified for building line charts.

Banking to 45° is a technique which selects an aspect ratio such that the average of all line segments is 45°. This maximizes the discriminability of the orientations of each segment in the chart. In practice, this is helpful at making a trend visible or detectable. Chart makers that attempt to exaggerate or obscure a trend violate this rule to achieve their goal. FIGS. 1A and 1D are examples of how the choice of aspect ratio can potentially obscure important trends.

Crafting the y-axis carefully is also an important part of creating good line charts. In deceptive line charts, the two most common techniques employed are y-axis truncation and y-axis inversion. Numerous studies have found that truncating the y-axis magnifies the extent of a trend. A small change can appear to be a large change depending on where the y-axis begins. Studies have also demonstrated that chart viewers have difficulty compensating for the visual effects of truncated axes even when it is clearly marked. Given how problematic truncated axes can be, chart makers must carefully think about the message they wish to convey before using them. Inverted axes are also an issue, as they are responsible for causing readers to have the opposite takeaway.

### Framework (100)

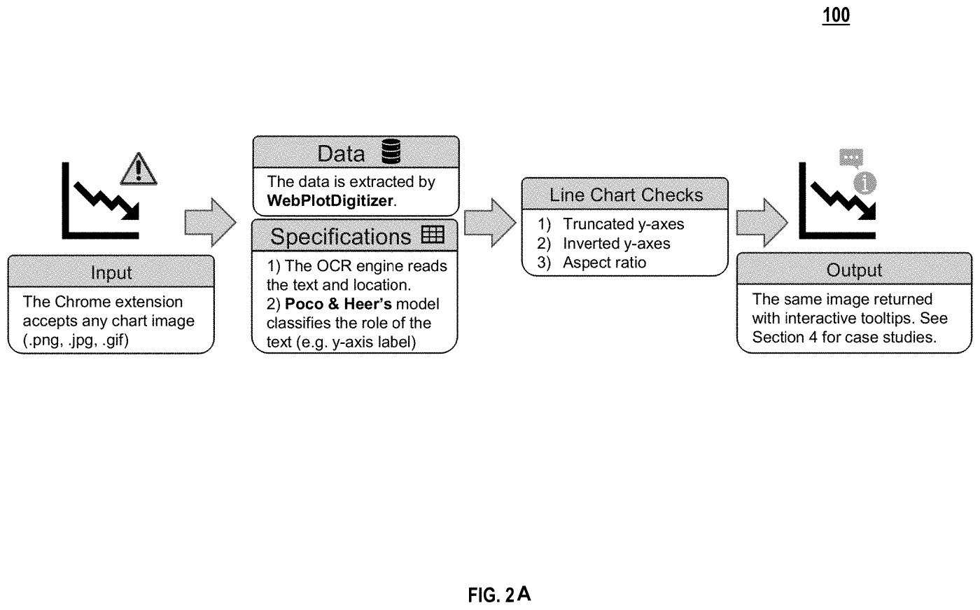

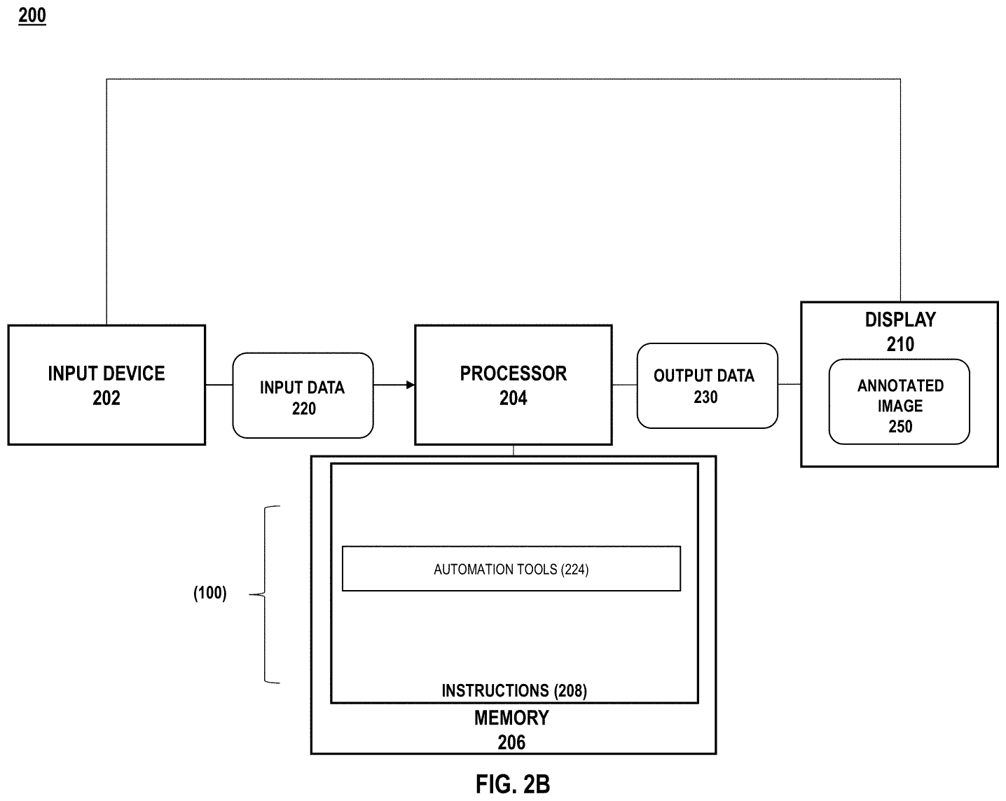

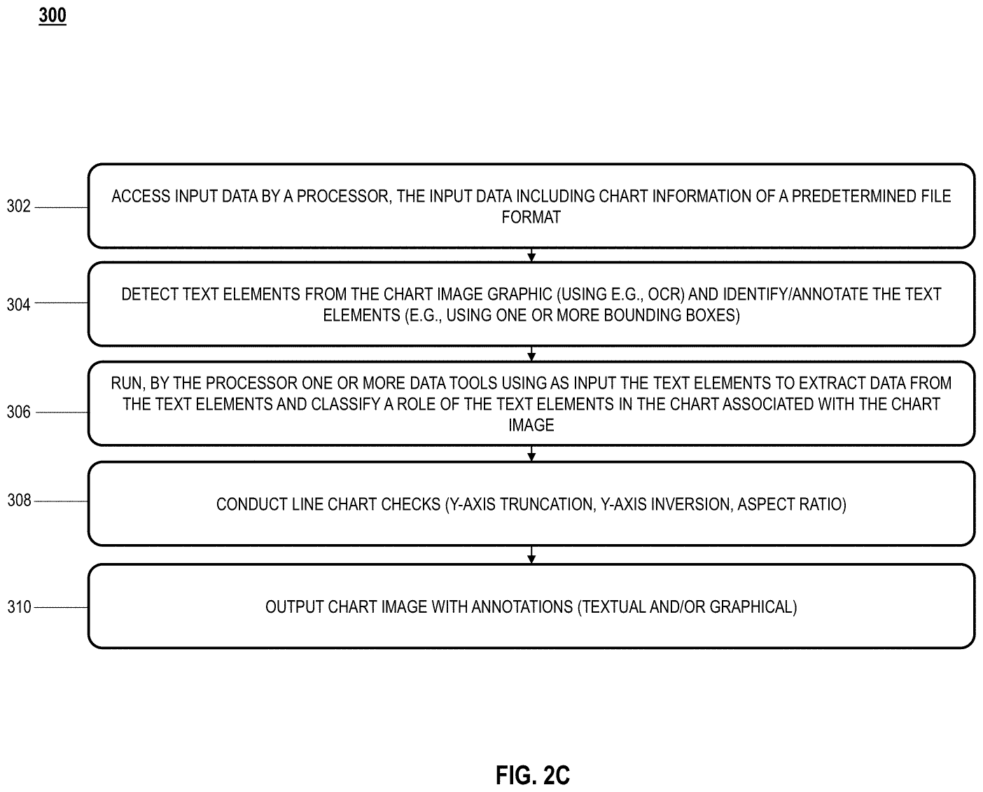

FIG. 2A outlines a framework 100 for annotating line charts in the wild, described further herein. FIGS. 2A-2B illustrate an example system 200 of possible devices and components supporting the framework 100 of FIG. 2A, and an example process flow 300 associated with the framework 100 and system 200. In general, an example system 200 supporting the framework 100 is a computer-implemented system that an include at least one input device 202, a processor 204, a memory 206 storing instructions 208 executable by the processor 204, and a display 210. As indicated in FIG. 2B, the processor 204 accesses input data 220 from the input device 202, the input data 220 including one or more chart images or associated information. The processor 204 then applies one or more data analysis tools 224 as defined by the instructions 208 to generate output data 230 which is made accessible or passed to the display 210 to render an annotated chart image 250; the annotated chart image 250 providing feedback about the accuracy (or lack thereof) of the underlying chart.

In general, the instructions 208 can be implemented as code and/or machine-executable instructions executable by the processor 204 (implemented via some computing device such as 1700) that may represent one or more of a procedure, a function, a subprogram, a program, a routine, a subroutine, a module, an object, a software package, a class, or any combination of instructions, data structures, or program statements, and the like. In other words, one or more of the features of the instructions 208 and/or framework 100 described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., memory 206), and the processor 204 performs the tasks defined by the code.

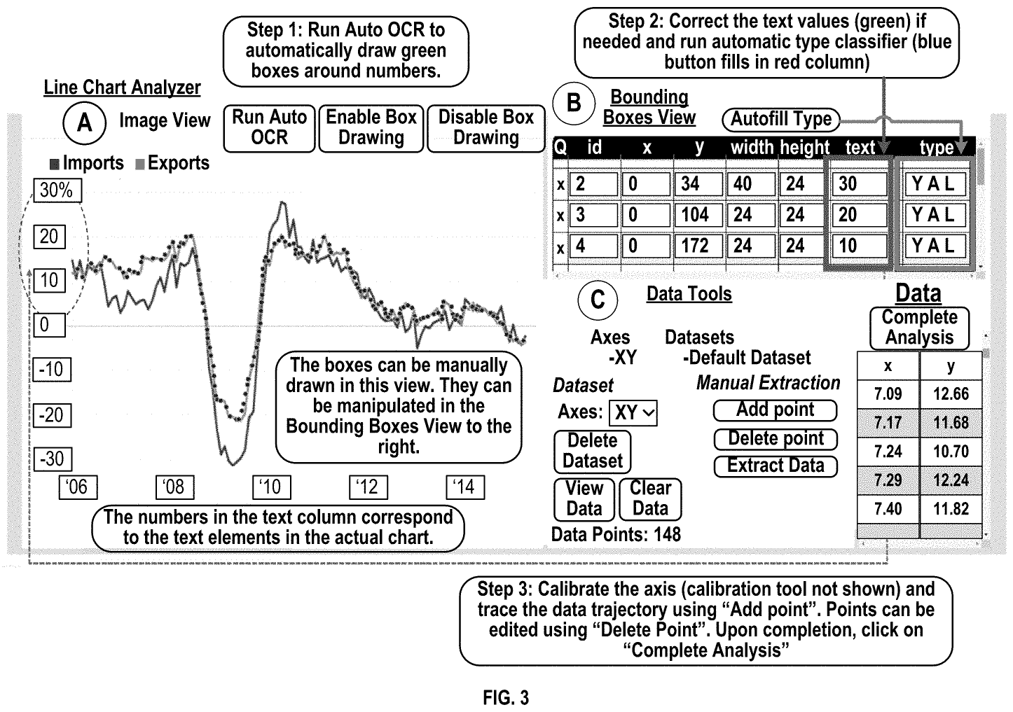

One example implementation of the framework 100 is embodied as a Google Chrome browser extension as a mechanism to support online content analysis, however other embodiments are contemplated. A browser extension featuring the framework 100 runs in the background, scanning for images in a webpage. Right-clicking any chart image and selecting the tool from the dropdown menu serves as the entry point for chart annotation. The framework 100 includes a plurality of automation tools that extract all information necessary for analysis and ideal reconstruction of the line chart. Although the framework 100 is fully automated, the framework 100 can be configured with logic to require a perfect 100% reading of the chart to complete the analysis. If a text-reader engine of the framework 100 reads numbers as other non-numerical characters (i.e., 100 as 1OO or lowercase o), then the engine will not work. As a result, the framework 100 can also incorporate a debugging tool into the pipeline to assist the automated chart reading as needed. This debugging tool includes three views shown in FIG. 3.

Image View This view contains the chart to be analyzed. Running an optical character recognition (OCR) engine is the first step, which detects the text elements in the graphic and draws green boxes around them.

Bounding Boxes View The Bounding Boxes View includes the coordinates of boxes that incorporate an area of extracted text from the graph to be analyzed, text from the graph, and the role of the text in the graph (e.g., y-axis-label). The information in the table is automatically populated from running the OCR engine. If the OCR makes errors, the table can be adjusted by updating the values directly. Changes to the table will be instantaneously reflected in the Image View.

The last column (“type”) requires information about the role that the text plays in the chart. Acceptable inputs in this column are x-axis-label, y-axis-label, y-axis-title, x-axis-title, text-label, and title. Alternatively, consumers have the option to classify all of the text roles by clicking on ‘Autofill Type.’ This attempts to fill in the role automatically.

Data Tools This view extracts data. Since the present framework 100 is targeted at univariate 2D line charts, the interface will ask for two points on the X-axis and two on the Y-axis to calibrate the axes. After this step is complete, using an “Add Point” button enables the mouse to be traced over the canvas. Once it is verified that the bounding boxes and data are correctly filled out, using a “Complete Analysis” button will analyze the graph in its entirety, annotating and outputting thumbnails of the chart reconstructed with accepted visual design rules.

During the creation of the experiment, 20 line charts were gathered and annotations were generated through the present framework 100. There were 274 text elements in total. The OCR engine recognized 256 of those labels, effectively giving an accuracy of 93.4%. Because each chart must have 100% accurate metadata for the annotation to work, the OCR result must achieve perfect accuracy to avoid human intervention. In the aforementioned sample, ½ of the charts were 100% correct. After correcting the text elements, one text classification model achieved a 100% accuracy on those text elements. The Data Tools View requires the user to calibrate axes to add data for all images. Based on this sample, boxes need to be fixed roughly half of the time, the text roles seldom need to be changed, and the data tools need to be used every time.

### Annotated Chart

Once the specifications and data have been collected, textual and graphical annotations are generated in a clickable and hideable tooltip. The possible annotations generated are listed below, and real-world output examples are shown below.

Detect y-Axis Truncation: If the y-axis is truncated, the baseline is annotated and text commentary is added to the origin of the graph. In addition, the original graph is drawn in D3.js and juxtaposed with the non-truncated counterpart. Finally, a color-blind friendly palette is used to signify that the truncated axes graph is potentially deceptive, and that the zero baseline should be considered.

Detect y-Axis Inversion: By convention, most y-axes are read bottom to top, low to high. If a graph is detected to violate this convention, then the y-axis truncation annotation is omitted (if there is any) and the baseline is annotated and text commentary is added to the origin of the graph to denote y-Axis inversion. Similar to the annotation above, the original graph is drawn with the inverted axis and juxtaposed with the right-side up counterpart. A color-blind friendly palette is used to signify that the inverted axes graph is potentially deceptive, and that the right-side up y-axis should be considered.

Comment on the Aspect Ratio: Using banking to 45°, the framework 100 can calculate an ideal aspect ratio and comment if the current aspect ratio is off by a multiplicative factor of log₁₀(AR_{large}/ARₛₘₐₗₗ)>0.5, where AR_{large} is the larger of the aspect ratio, ideal or current, and ARₛₘₐₗₗ is the smaller aspect ratio. This corresponds to half an order of magnitude. In practice, aspect ratios that are too similar in value do not change the graph. In another variant of banking to 45°, similar aspect ratios tend to form clusters and must be filtered out to a single value.

### Case Studies

In this section, the results of the present framework 100 are presented across three different line charts for analysis.

### VisLies 2017 Lake Mead Line Chart

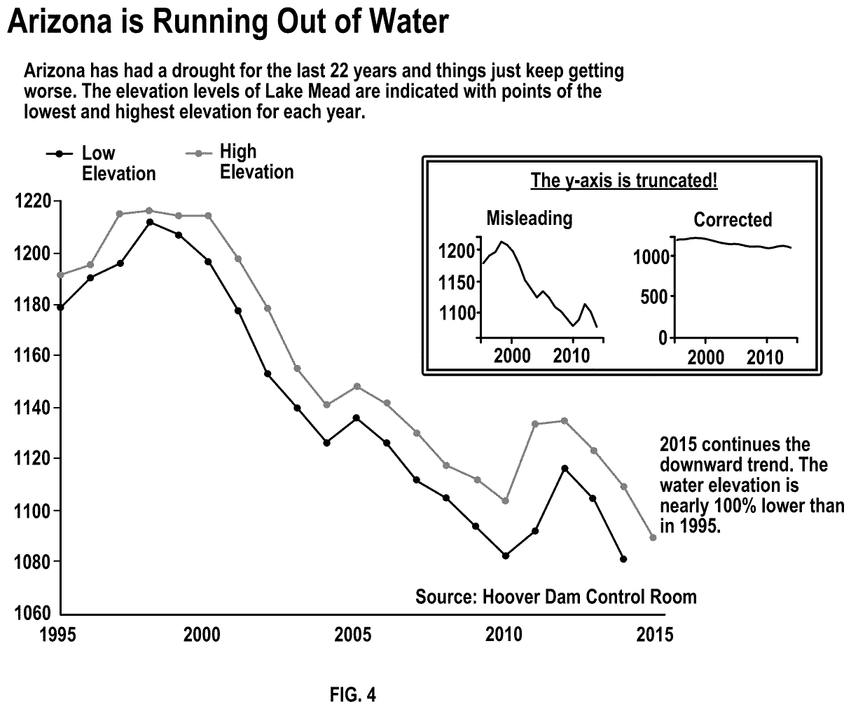

To show how the present framework 100 works on a truncated axis, a Lake Mead line chart (FIG. 4) taken from VisLies 2017 is presented. The chart data shows Lake Mead water levels decrease from 1220 feet to 1080 feet over the course of 20 years (the unit “feet” is not shown in the figure). This is a 11.4% decrease in value. However, since the axis is truncated, the line nears the x-axis which can give the impression that the lake has run completely dry. The title “Arizona is Running out of Water” also helps to exaggerate this point. Without looking intently at the values of the y-axis, a reader can potentially be misled into thinking that Lake Mead has completely run out of water, despite a 10.8% decrease in the water value. After completing the analysis, the framework 100 recognizes that the sharp downtrend is only a decrease of 10.8%, while marking the y-axis baseline at 1060. In addition, the framework 100 shows the original graph and constructs an additional graph with a zero baseline, which allows the visualization consumer to see what the graph looks like if the y-axis were not truncated.

### Stand Your Ground Infographic

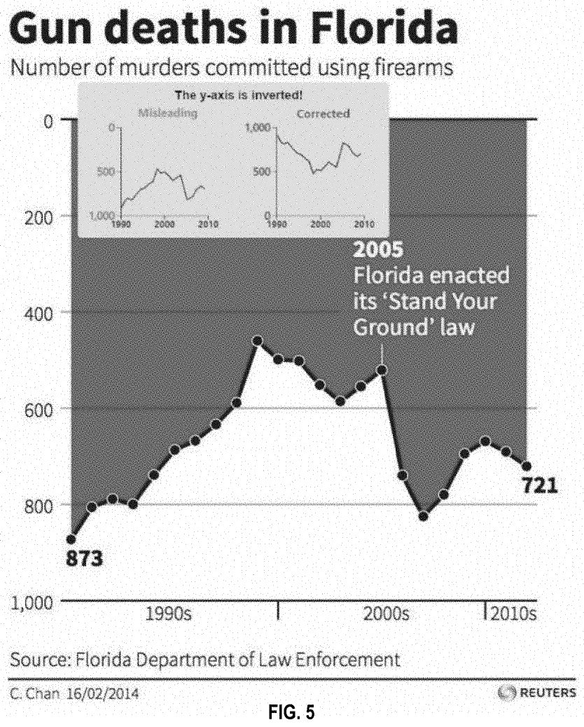

A second case illustrates how the framework 100 works on an inverted axis. This section analyzes a highly controversial and misleading graphic regarding gun deaths in Florida, shown in FIG. 5. In 2005, Florida enacted its “Stand Your Ground” law, which provides that a person may use deadly force in self-defense. Following the passage of this law, the number of gun deaths in Florida increased. Since the chart has an inverted y-axis, it appears that there was a decrease in gun deaths after the passage of the law. After this graphic was published on Thomson Reuters, multiple US news sources expressed annoyance at this chart for its deceitful design

The OCR engine makes no errors in reading the chart. However, the 1,000 number at the bottom of the y-axis contains a comma, which must be removed, as the analysis engine only supports numerical inputs. Also, the values of the x-axis are 1990s, 2000s, 2010s. The ‘s’ must be removed for the same reason above. The final result is shown in FIG. 5, and the corrected graph is drastically different from that of the original. The orange and blue markings on the annotation show that the y-axis does not follow normal line chart guidelines.

### Sunspots Dataset

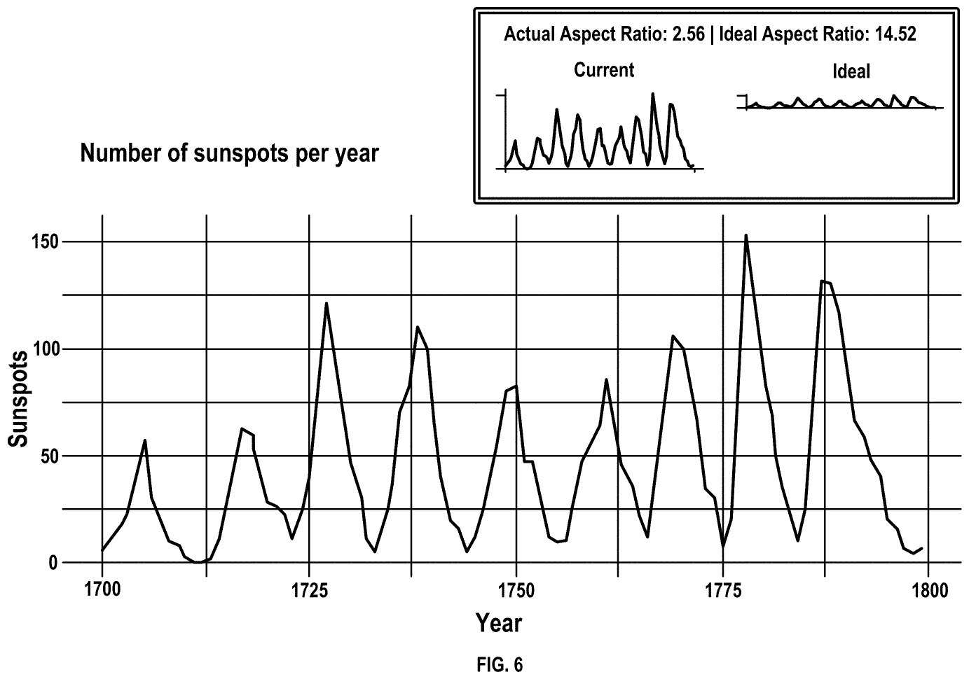

To show how the framework 100 works to calculate an ideal aspect ratio, a final case (FIG. 6) presents the sunspots dataset. According to the analysis, the axes are not problematic. However, one design choice that may be suboptimal is the aspect ratio. Since the data is sharply increasing and decreasing in cycles, banking to 45 suggests that this graph should be more oblong given the angle of the line segments. This can be seen when investigating the infobox at the bottom right corner of the graph. The aspect ratio is 2.56, while using the banking to 45 technique suggests that the ideal aspect ratio should be 14.52. The thumbnails show that the trends look considerably different, and help the visualization consumer see an alternate trend in the data that cannot be seen readily. This case shows that by manipulating the aspect ratio, changes within the graph can be exaggerated.

### Experiment

While the case studies demonstrate that the line chart annotation framework 100 is effective at identifying y-axis truncation, y-axis inversion, and aspect ratio misuse, it was necessary to assess whether annotations provided by the framework 100 were effective in helping general visualization consumers identify deceptive visualizations. Experiments were structured according to message exaggeration and message reversal and also were structured to test whether the framework 100 steers the participant towards a different response when compared to the absence of the framework 100. As treatments were being designed for the experiments, banking to 45 and aspect ratio manipulations were considered. However, after consideration, it was decided that this was a technique that was primarily found in academic writings and charts with highly complex trends. As such, it was decided to focus assessments on the annotations that are designed to cater to a lay audience. Truncated axis and inverted axis charts were selected for the experiment and focused on simpler trends with easy-to-understand questions, while still testing for deception techniques that are widely used.

### Chart and Question Construction

Numerous empirical studies have already confirmed the deceptive effects of deceptive visualizations when compared to a controlled baseline. Therefore, there is no need to construct controls to determine whether people can be misled by deceptive line charts. Instead, this study focuses on exploring if exaggerated line charts are more easily identified with or without annotation by the framework 100. 11 line charts with truncated axes were constructed for the message exaggeration type of deception and 11 line charts with inverted y-axes were constructed for the message reversal type of deception. For the message exaggeration category, a question was asked in the format “How much was the increase/decrease of [Y] change between [time range]?” The possible answers were on a Likert Scale from 1—Slight Increase/Decrease to 5—Drastic Increase/Decrease. The participant was explicitly told if a chart's value is increasing or decreasing to completely eliminate ambiguity in the response. In addition, this type of message deception is unidirectional and will only require the use of a single-tailed statistical test. For the message reversal type of questions, the question was asked in the format “What happened to the value of [Y] between [time range]”? The possible answers were “Increased/Improved”, “Not Sure”, and “Decrease/Declined.” There is only one correct answer per question, and the participant was scored based on their response.

Educational background and political beliefs have been noted to play a large role on the per-participant perception of a graph. Therefore, data from neutral topics was presented to avoid the interference of personal biases in experiment results. For example, some of the graphs that are shown are sales of fictional companies, and the price of milk over time.

Finally, previous empirical research in deceptive visualizations relied on self-reported measures of skill (i.e. Are you familiar with line charts?). Self-reported measures are disadvantageous, as they are known to have validity problems; participants may feel the need exaggerate or understate a response due to personal emotions. Boy et al. developed methods to assess the data visualization literacy of an individual using item response theory. More recent advances in this field led to the development of the Visual Literacy Assessment Test (VLAT), which reliably tests a participant's data visualization reading skills. With a validated test to gauge a participant's skill level, a more reliable measure than a self-reported score can be relied on. VLAT was used to measure the skill level of participants and assess for individual differences with respect to graph comprehension and visual literacy.

### Experimental Design and Considerations

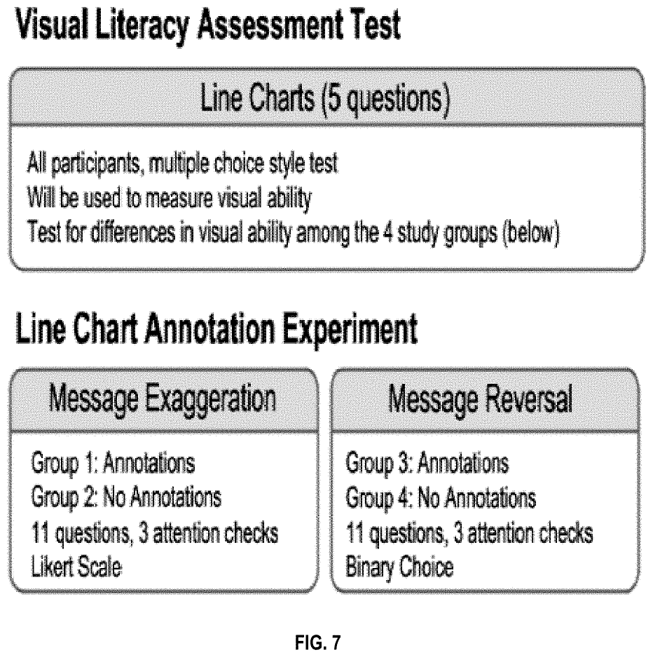

FIG. 7 provides an overview of the experimental design procedure. First, all participants completed the 5 line chart questions from the Visual Literacy Assessment Test (VLAT). A participant's score on this test reflects their visual ability. The participant is then randomly assigned to one of four study groups for a between-subjects design.

For the charts that fall into the message exaggeration type, there are two groups (Group 1 and Group 2). While Group 1 and Group 2 will see the same series of 11 charts, Group 1 had access to the framework 100, while Group 2 did not. Similarly, for the message reversal type of deception, participants were split into two groups (Group 3 and Group 4). These two groups saw the same 11 inverted y-axis charts, but Group 3 had access to the framework 100, and Group 4 did not. This experiment setup tested if the presence of the annotations steered the participant towards a more controlled response (for message-exaggerated charts) or the correct response (for message-reversal charts).

Participants were recruited from Amazon's Mechanical Turk (MTurk). For the final experiment, 104 unique persons were qualified based on two criteria: (1) their current location is in the United States and (2) their previous task approval rate is greater than or equal to 98%. Completing the experiment took on average 7.22 minutes and participants were paid $2.00 upon successful completion (a wage of approximately $16 per hour). All 122 participants answered all 3 attention check questions correctly. One participant who completed all 19 questions in less than 3 minutes was removed.

TABLE 1
BASIC DEMOGRAPHIC INFO OF PARTICIPANTS

| | Groups 1 & 2 | Groups 3 & 4 |
|---|---|---|
| Education | [26, 37] | [19, 40] |
| Gender | 43 M, 20 F | 37 M, 21 F, 1 no answer |
| Age | μ = 37.1, σ == 11.4 | μ = 39.4, σ = 12.6 |
| Total | 63 | 59 |
| Participants | | |

### Hypotheses

Message Exaggeration Visual aids provided by the annotations will steer Group 1 participants to pick lower category answers, which align with the factual interpretation of the graph. In contrast, Group 2 participants, in the absence of the tool, will generally pick higher category responses, which are associated with exaggerated perceptions of trends.

Message Reversal Visual aids provided by the annotations will alert Group 3 participants to deceptive chart construction. Thus, Group 3 participants will choose correct answers at a higher frequency compared to Group 4 participants.

### Statistical Analysis

Data processing, visualization, and analysis were performed in the statistical computing software JMP® and SAS®. Due to the categorical nature of the responses (i.e., binary or ordinal), a flexible family of models called generalized linear mixed models (GLMM) were used for both estimation and tests of significance. When the response is binary, as in the Message Reversal questions which were designed to have correct answers, a logistic regression model with random intercepts for Questions was used, which facilitates the generalization of inferential results to cases outside of the study. For ordinal responses from the Message Exaggeration experiment, the resulting GLMM is a proportional odds model, similarly with random intercepts for the reason just stated.

TABLE 2
VLAT SCORES

| | Correct | Incorrect | Percentage |
|---|---|---|---|
| Group 1 | 138 | 38 | 78.4% |
| Group 2 | 149 | 30 | 83.2% |
| Group 3 | 138 | 35 | 79.8% |
| Group 4 | 130 | 33 | 79.6% |

Tests of significance were performed using Type III Tests of Fixed Effects (for each analysis, Group is the fixed effect). Odds Ratios (OR) were estimated for sensible interpretation of results. Odds ratios are ratios of odds between two groups. Odds are ratios between the probability of an event of interest (e.g., a correct answer) vs. the inverse event (e.g., incorrect answer). Thus, a “significant difference” between two groups is implied under rejection of the null H₀: OR=1 in favor of H₁: OR>1.

### Results

Data Visualization Skill Test Questions 1-5 and the VLAT line chart questions across all groups (1, 2, 3, and 4) were analyzed to determine if there is uniformity in the participants' data visualization skills. Table 2 presents a cross-tabulation of correct and incorrect responses for each group. It is observable that solely based on counts, there is very little difference in the proportion of correct and incorrect answers among the 4 groups. A logistic regression model with random intercepts was used to test the hypothesis that all 4 groups are equal. Fixed effects tests did not reject the null hypothesis (p>0.70), suggesting that there was not enough evidence to conclude that there are differences among the groups. Hence, based on this result, one can comfortably assume that participants across the groups have approximately similar levels of visual literacy.

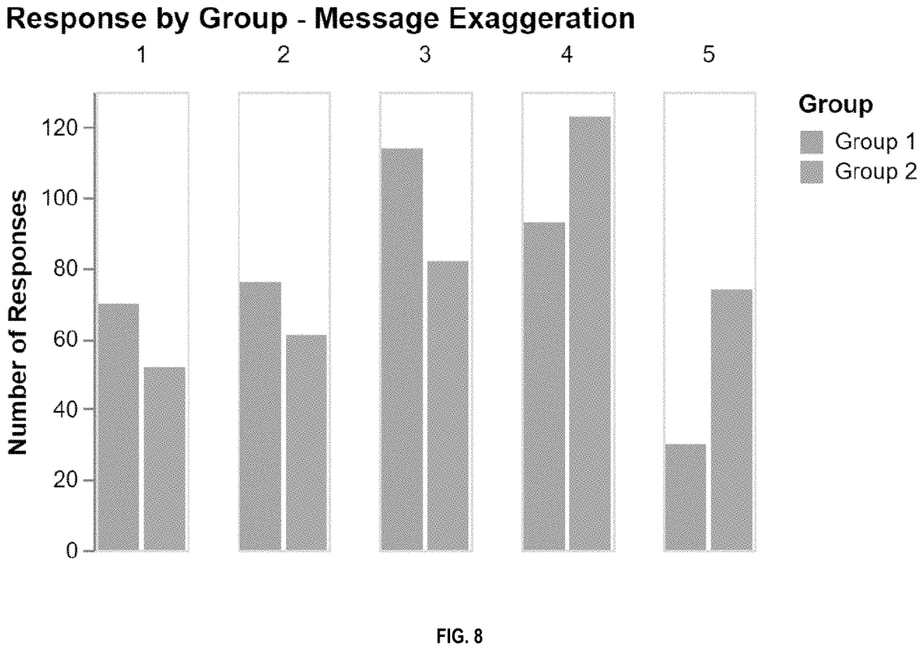

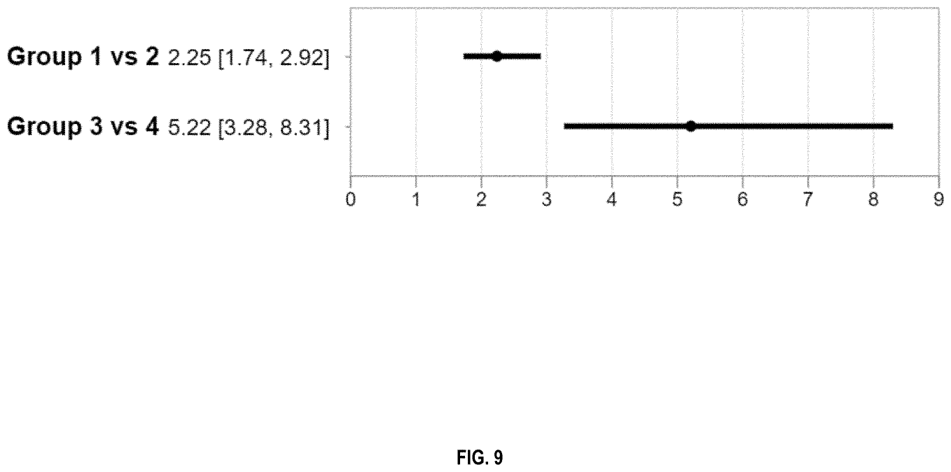

Message Exaggeration Responses were aggregated from n₁=31, n₂=32 unique participants from Groups 1 and 2, respectively. All participants passed the attention checks in Questions 10, 15, and 19. FIG. 8, which compares the frequency of raw responses at each category between the two groups, suggests that Group 1 participants answered 1's or 2's more frequently. Group 2 participants more frequently answered 4's and 5's. This hypothesis is formally tested using a proportional odds model with random intercepts for Questions. The test of the Group fixed effect showed a significant difference between the two groups (F(1, 760)=37.36, p<0.0001). The odds ratio between the two groups was also estimated at OR=2.25 (see FIG. 9), which is significantly different from 1 (H₁: OR>1, p<0.0001). The result implies that, compared to Group 2, Group 1 participants provided responses at the lower end of the scale more frequently by a factor of 2.25. This means that for every 100 participants, approximately 70 will answer either a 1 or 2 in the presence of the present framework 100. In comparison, only 30 will do so in its absence.

Message Reversal Responses were aggregated from n₃=30, n₄=29 unique participants from Groups 3 and 4, respectively, and similarly, all participants passed the attention checks in Questions 10, 15, and 19. Those who answered “Not Sure” were marked as incorrect. Table 3 presents the tabulated frequency of correct and incorrect responses for the two groups across all questions. A quick observation of the cross-tabulated answers already presents some evidence that Group 3 tends to provide correct answers more frequently. To formally test this hypothesis, logistic regression with random intercepts was used, a specific form of GLMMs for binary (correct vs. incorrect) responses. Type III tests of fixed effects again show that the two groups are significantly different (F(1, 712)=48.94, p<0.0001). The OR estimate between the two groups is 5.22 (see FIG. 9), which implies that Group 3 is approximately 5 times more likely to provide a correct answer than an incorrect answer in comparison to Group 4. With these odds, it is estimated that 83 out of 100 people will not be deceived by the graph in the presence of the present framework 100, while only 17 will provide the correct answer in its absence.

TABLE 3
RESULTS OF GROUPS 3 AND 4

| | Correct | Incorrect | Accuracy |
|---|---|---|---|
| Group 3 | 344 | 27 | 92.7% |
| Group 4 | 254 | 99 | 72.0% |

### Conclusion

The present disclosure describes a framework 100 to help detect deception in line charts through textual and visual annotations. Case studies described herein present scenarios where the framework 100 identifies and annotates line charts that violate conventions.

The main bottleneck of framework 100 is the OCR stage. There are two current limitations. First, the data extraction speed needs is currently well below interactive rates. In FIG. 4, the image size was 1996×1838 and it took 75.52 seconds to process the single image on a quad-core Intel i7 CPU. Second, the data extraction accuracy may still requires human intervention. Again, in FIG. 4, the OCR tool makes minor errors and mistakes certain characters for other similar characters, such as 1080 being read as 108 u. The ideal situation for the present framework 100 would be a completely automatic pipeline that immediately can provide image overlays and annotations as people browse the web.

Along with the processing limitations, there are also subtle nuances of graph design that need to be considered. Choosing y-axis ranges and aspect ratios are scenario-specific tasks. Storytelling through charts is extremely nuanced and the present framework 100 cannot address each situation or concern separately. In this work, the framework 100 detects and corrects truncated y-axes, inverted y-axes, and non-ideal aspect ratios using banking to 45°. However, there are times where using truncated and inverted axes are completely justified. There are also times where using banking to 45° results in a suboptimal graph. This led to the invention of multiscale banking to 45°, which combines spectral decomposition to bring out trends at different frequency scales. As such, further research needs to be done in exploring if annotations, such as those proposed in this research, would accidentally decrease trust in graphs that were well designed, but break with traditional conventions.

The annotations can additionally be extended to bar charts, pie charts, or any other widely used data visualization techniques that people see on a regular basis. Extending this work to bar and pie charts can cover almost 90% of all data visualizations in the wild.

Guidelines for y-axis parameters in line charts can also be generalized to other chart types. Area charts are line charts with the portion underneath shaded, and has the visual representation of volume. Like line charts, they are generally used to display time series or sequential data. Outside the visualization research community, they are interchangeably used with line charts due to their similarity. Bar charts are used to display different types of data, but are similar to line charts in that the primary information encoded is along the y-axis. Thus, y-axis truncation and y-axis inversion apply to this chart type as well.

In some embodiments, the framework can incorporate natural language processing (NLP) to help prevent the spread of deceptive visuals and misinformation. Detecting the tone or sentiment of the graphic can assist in pinpointing the author's innate biases. Models have been trained to spot fake Amazon reviews, deception in court cases, fake news, etc. With the integration of NLP models, this tool can be extended to detect questionable texts embedded in images, prompting the visualization consumer to look into a more credible source for confirmation.

### System 1000 and Framework 1001

A second example framework 1001 shall now be described that shares some features with framework 100. Data-driven news utilizes the persuasive power of data visualizations to tell a story. While the use of convincing rhetoric is mostly effective, incorrectly designed charts and false information are inevitable. These malformed charts or texts make their way into the public and can potentially deceive millions of readers. Informed by findings that suggest priming critical thinking skills are the best way to prevent the spread of misinformation, framework 1001 is presented for linking graph data and article text in news articles and generating annotations for detecting fake news and improving reader engagement. Utility of framework 1001 is demonstrated through case studies on recent publications from The Economist magazine. Finally, the framework 1001 and its associated tools are tested to the web and a crowdsourced study conducted to examine the effects on a real-life audience.

### Introduction

Quick and easy access to news in today's age is an invaluable resource for everyone. People use news in many ways, whether it be for getting the latest updates or opinions on a topic or for making informed decisions in the stock market. In order to make stories more accessible, journalists condense large amounts of quantitative data into visualizations, such as line graphs, for faster comprehension. In this way, both textual and graphical elements help convey critical information for the audience. This concept has become popular lately and has been termed data journalism.

Data journalism has existed for a long time, and its popularity is only growing. Platforms such as the Economist, New York Times and FiveThirtyEight are prominent news outlets that publish data visualizations to accompany their editorials. In order to create a visualization, data scientists must sift through a vast repository of unstructured data. They then collaborate with journalists and graphic designers to create charts that best drive the intended message to the audience. The inclusion of data in news stories strengthens the author's point, engages the audience, and improves information retention. A compelling visualization in itself can stand alone as incontrovertible rhetoric.

However, there exist barriers to comprehension in data journalism. One such issue is deceptive visualizations, which are charts and graphs that lead the reader to have an altered understanding of the data. Misrepresentations of the data can be intentional or unintentional, such as through lack of expertise in graphic design. The visualization community has addressed this problem by building linters, which are software tools that correct chart construction errors during the design stage. A more problematic issue in data journalism is fake news, or information that is outright and verifiably false. Similar to deceptive visualizations, this can also be intentional (e.g., purposeful false information) or unintentional (e.g., inadvertent errors). Fake news has widespread consequences; it threatens journalism and freedom of speech, it can damage a subject's reputation, and it instills false memories in audiences. Fake news should ideally be stopped by fact checkers and content policing strategies, but some still make its way to the public, misinforming millions of readers. Yet, the true effects of fake news are difficult to quantify and still not well understood.

Researchers have found ways to pinpoint and analyze the spread of misinformation. There are ways to detect fake news by observing the way it spreads on social networks, by examining the writing style, or by looking at the credibility of the source. Although helpful, existing tools are computationally expensive resources and require expert knowledge to be usable. Given the adverse effects of fake news, more scalable solutions with lower barriers to entry are needed to address the general public.

Described herein, the framework 1001 can include a browser tool executed by at least one processor that annotates data-driven news for detecting potential deception. The framework 1001 is inspired by recent literature that suggests that improving or priming critical thinking prevents misinformation. The browser tool of the framework 1001 reads data graphs and their accompanying article and links the relevant excerpts in the article to the data. Additionally, the tool can employ natural language processing (NLP) techniques to fact-check claims within the article as well as output additional annotations for encouraging critical evaluation of its content. Finally, the pipeline of the browser tool is a fully automatic, end-to-end solution. Case studies are presented on altered articles taken from The Economist in order to demonstrate its utility. Finally, crowdsourced experiment is designed and conducted to evaluate the usability and effectiveness of the browser tool. Results conclude that the browser tool is effective at enabling audiences to recognize false information and connecting text with visualizations. Given the feedback received from participants, it is argued that a tool like this is beneficial for enhancing the news-reading experience for the public.

In summary, contributions include:
A technique for linking data visualizations with their corresponding article text;
A novel framework (1001) for automatically annotating data-driven articles for fact-checking and reader engagement, and;
A study exploring the effects of the annotation browser tool on reading comprehension and discerning fake news.

### Technical Problems

The following section summarizes technical problems and challenges associated with deceptive visualizations, fake news detection, and narrative visualizations. The framework 1001 is responsive to such technical problems.

Deceptive visualizations are representations of data that lead readers to have an understanding of the data that differs from the actual data. Even though a visualization may have an accurate data-to-mark mapping, this alone is not enough to guarantee an accurate representation of the underlying dataset. Researchers have studied and quantified how certain chart construction techniques influence a reader's perception of the data. For example, Pandey et al. show how truncating y-axes exaggerates the effect size on the reader. Munzner notes that introducing unnecessary 3D elements to graphs leads to more inaccurate readings and comparisons. Most recently, Lo et al. formally taxonomize misleading visualizations based on how they mislead. Their work divides deceptive visualizations into four major categories: informal fallacies in visualizations, exploiting conventions and data literacy, deceptive tricks in uncommon charts, and understanding the designers' dilemma (which is despite the author's best efforts to make a honest graph, the chart still appears misleading).

Correcting a reader's perception of a deceptive visualization is a difficult problem. Correll et al. show that the subjective impact of truncated y-axes persists even when the truncation is clearly demarcated.

### Fake News Detection

Zhou and Zafrani broadly define fake news as false information presented as news, whether intentional or not. One of the most common ways to detect fake news is from a knowledge-based technique, colloquially known as fact-checking. Manual fact-checking relies heavily on domain experts but lacks scalability and cost effectiveness. To address these issues, automatic fact-checking was developed, which utilizes a knowledge base consisting of facts to verify the authenticity of news. The truthfulness of a claim is determined by comparing it to the facts within the knowledge base.

Adding additional information or features can help boost the robustness of fake news detection models. Zhang et al. incorporate information about the authors to augment fake news detection capabilities. Karduni et al. develop Verifi2, a visual analytics system that investigates information on social media sites. Their system considers linguistic, network, and image features to discern fake news accounts. Wu et al. take a different approach and consider the how a news story is shared in order to detect information. This technique is known as propagation-based detection and would later set the stage for future works that also use this method. Vosoughi find that false news spreads faster and farther than true news. By comparing the propagation graphs of false news when compared to authentic news, the graphs of false news posts had larger cascade depths, breadths, and sizes. RumorLens uses a combination of NLP, propagation networks, and features about the author to analyze false information on social media. These aforementioned works require a combination of technical knowledge, access to nonpublic data, and computationally expensive resources. In order to cater to the general public, the framework 1001 offers a lightweight tool without sacrificing functionality.

### Narrative Visualizations

Data visualizations seldom exist alone. They are usually accompanied by graphical elements for appeal and accompanying text for driving the main points. Segel and Heer define this type of storytelling as narrative visualization, and within their framework, they emphasize the importance of interactivity and annotations. Kosara and Mackinlay also stress the importance of interaction and annotations in storytelling. Figueiras find that interactivity in narrative visualizations increased engagement and recall. When readers encountered stories without any interactive components, the overall attitude was that they did not learn anything new. Some of the participants in the study suggested that mouseover tooltips could have made the visualization more interesting. Hullman and Diakopoulos propose a visualization rhetoric framework and list annotation as one of the four main editorial layers in storytelling; the others are interactivity, data, and visual representation.

Interactivity: When interaction is available in a visualization, audiences are more likely to remember the information. CLUE is a model that tightly integrates exploration and storytelling in visualization for enabling analysts to seamlessly switch between the two. Voder augments visualizations with interactive data facts to aid in interpreting visualizations. Whereas the above works focus on interacting with data visualizations, research has also explored interaction with text components as well. Kwon et al. develop VizJockey, a technique that enables readers to easily understand the authors' intended view through orchestrated visualizations. Marcus et al. develop MuckRaker, an interface that enables news readers to access a repository of relevant context through a web interface. Beck and Weiskopf outline potential interaction techniques to link visualization and text in a call-to-action paper. Later, Latif et al. materialized Beck and Weiskopf's vision and construct a framework that takes text markup, a related dataset, and a configuration file to produce an interactive webpage. The resulting document supports visual highlighting, details on demand, and bushing-and-linking. The framework 1001 extends their research to better support articles found in the wild. Firstly, internet news is exploratory; thus content must be generated on the fly. Second, while Latif et al. require manual declarative programming to function, the framework 1001 is fully automatic, eliminating the complex training stage.

Annotation: Much research has been devoted to how to automatically generate annotations. SumTime produces textual summaries from time series data by using pattern recognition algorithms. Chen et al. propose a model for generating text captions for visualizations by modeling the relations between figure labels. By applying reinforcement learning to optimize their model, they find that their technique generates long, robust captions, suitable for automatic captioning of large amounts of visualizations. Later, Qian et al. take a natural language generation approach to captioning by combining multiple caption units together with varied stitching patterns. Recent work has also incorporated online news Contextifier automatically annotates stock charts using content within a news article while taking into account linguistic relevance and visual salience. NewsViews is a news visualization system that automatically outputs annotated maps. TimeLineCurator is an authoring tool that extracts event data and leverages temporal information to generate annotated timelines.

### Annotating Data Driven News

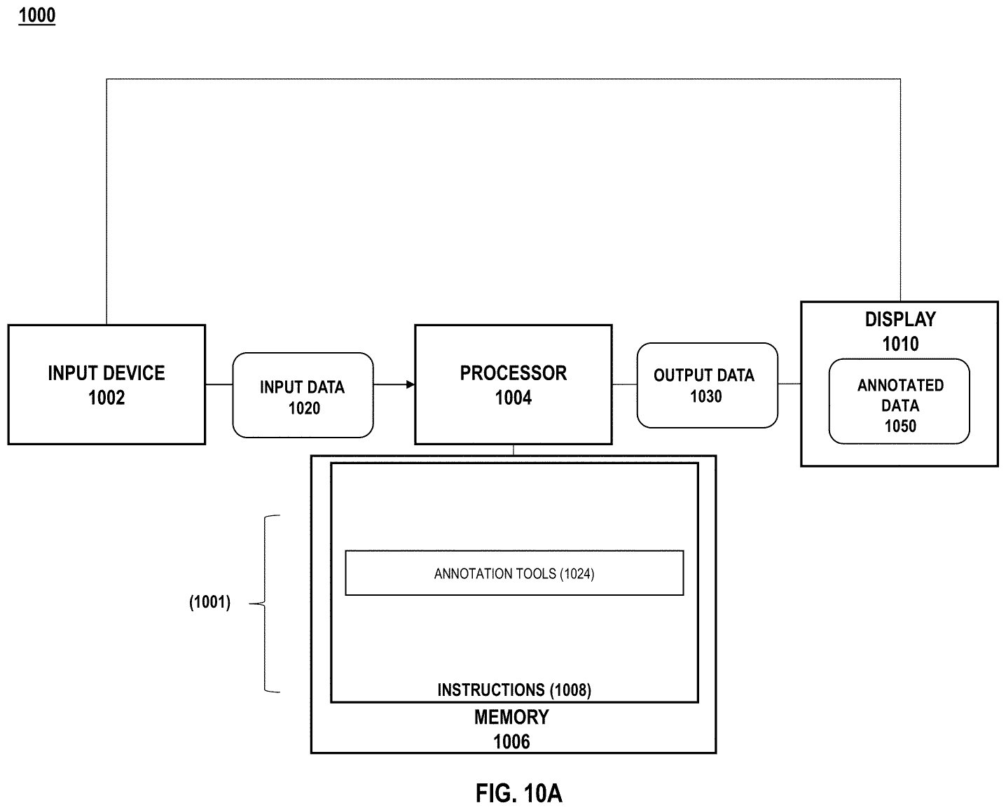

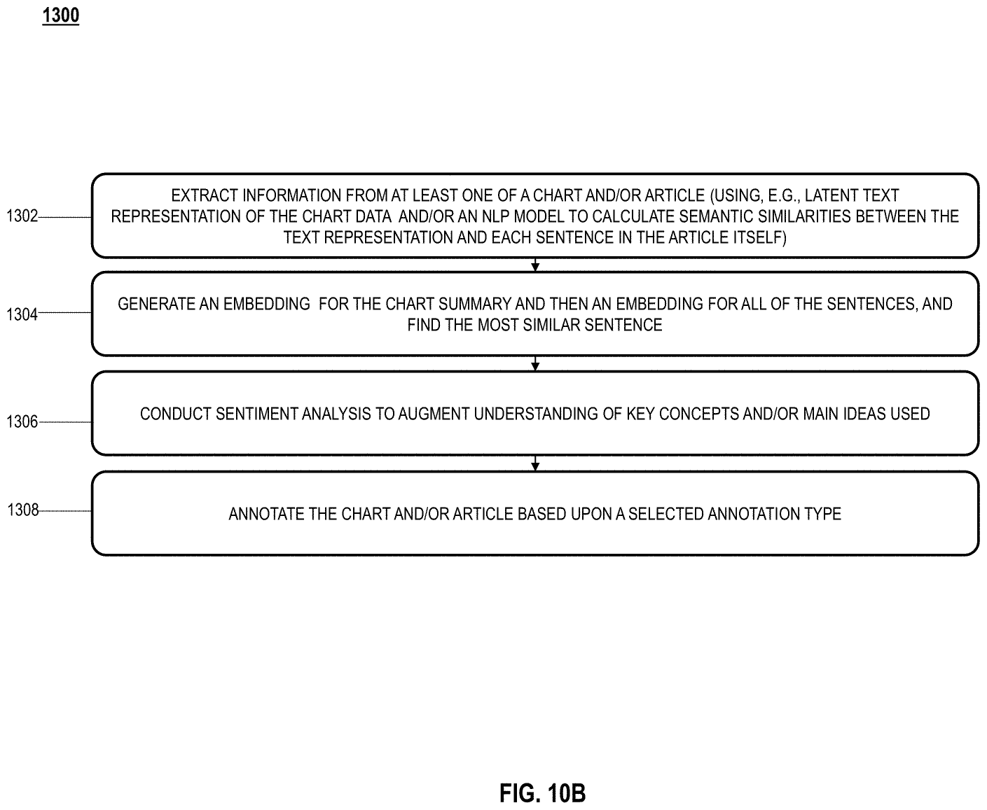

FIGS. 10A-10B illustrate an example system 1000 of possible devices and components supporting the framework 1001, and an example process flow 1300 associated with the framework 1001 and system 1000. In general, similar to the system 200, an example system 1000 supporting the framework 1001 is a computer-implemented system that an include at least one input device 1002, a processor 1004, a memory 1006 storing instructions 1008 executable by the processor 1004, and a display 1010. As indicated, the processor 1004 accesses input data 1020 from the input device 1002, the input data 1020 including one or more charts and/or articles (e.g., news article with chart graphics). The processor 1004 then applies one or more data analysis and/or annotation tools 1024 as defined by the instructions 1008 to generate output data 1030 which is made accessible or passed to the display 1010 to render annotated data 1050; the annotated data 1050 providing feedback about the accuracy (or lack thereof) of the chart and/or article.

In general, the instructions 1008 can be implemented as code and/or machine-executable instructions executable by the processor 1004 (implemented via some computing device such as 1700) that may represent one or more of a procedure, a function, a subprogram, a program, a routine, a subroutine, a module, an object, a software package, a class, or any combination of instructions, data structures, or program statements, and the like. In other words, one or more of the features of the instructions 1008 and/or framework 1001 described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., memory 1006), and the processor 1004 performs the tasks defined by the code

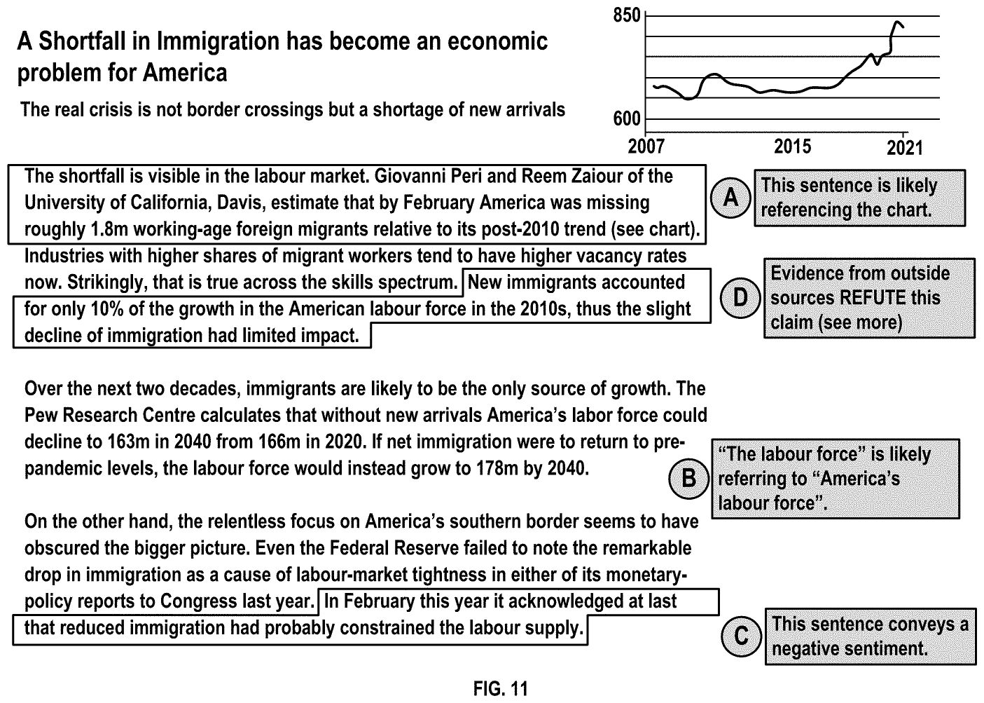

Given the widespread use of online news and social media, effective tools must be established for preventing the spread of potentially false information. The framework 1001 is an interactive tool for automatically annotating data-driven news for misinformation (FIG. 11).

### Motivation

Recently, researchers have been interested in software tools that detect and annotate errors in visualizations. These tools are called “linters,” named after static code analysis plugins intended to flag programming mistakes. For example, VisuaLint and VizLin-ter are tools that detect errors in VegaLite visualizations. McNutt and Kindlmann implement a similar tool for Matplotlib charts. Fan et al. expanded on previous works by extending support to all line charts, regardless of format. However, with the rise of narrative visualizations, text information can also supplement visualizations. With the combination of texts and graphs, detecting errors in the text and linking data to text are new problems that arise. Metoyer et al. propose a novel method that links a writer's narrative with basketball game data. They implement bidirectional interaction from visualization to text and text to visualization to enrich reader exploration in both directions. The inventive concept of framework 1001 extends beyond this simple case study on sports as it is applicable to all articles found on the internet.

Recent literature also examines individual preferences regarding what type of annotations to include. Stokes et al. find that readers generally prefer charts with the largest number of textual annotations over charts with fewer annotations. Charts with large amounts of annotations were not penalized. Tsfati note that people tend to relate with simple and coherent statements. Thus, a refutation of false information may be less effective when the refutation is lexically more complex than the false information itself. Informed by this literature, the inventive concept of framework 1001 is configured to generate adequate annotations and keep them simple to understand.

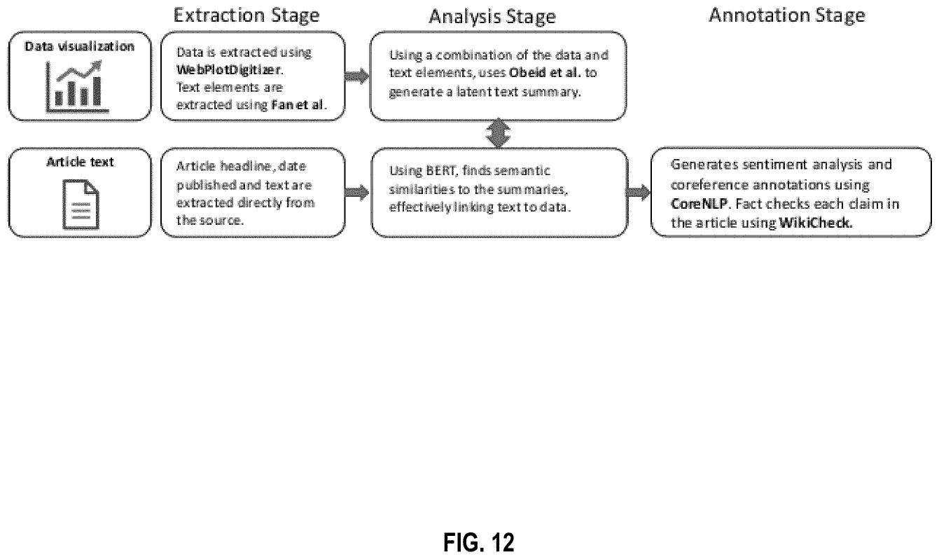

Referring to FIG. 12, an end-to-end pipeline of the framework 1001 is illustrated. Extracting information from the charts and article is the first step in the pipeline. Data is extracted with the help of WebPlotDigitizer, and the title of the chart is extracted using an interface by Fan et al. The title of the chart refers to the text that do not correspond to the axis labels and legends. Using this information, we use Obeid et al.'s model to generate a chart summary, which serves as a latent text representation of the chart data. For the article, we use BERT, a state-of-the-art NLP model to calculate semantic similarities between the text representation and each sentence in the article text itself. We generate an embedding e_{chart} for the chart summary and then an embedding for all of the sentences eᵢ, where i is the index of the sentence. We then find the most similar sentence by calculating the cosine distance between the embeddings, defined as:

$$cos ( x , y ) = \frac{x \cdot y}{‖ x ‖ \cdot ‖ y ‖} \qquad ( 1 )$$

The most similar sentence is the arguments of the maxima of the cosine distance function:

$${argmax}_{i} cos ( {e}_{chart} , {e}_{i} ) , \qquad ( 2 )$$

which effectively links the chart to the text. The main purpose of this functionality is motivated by literature that show that interactive documents connecting text with visualizations facilitate reading comprehension. Linking chart to text has been explored before, but there is not a fully-automatic approach for solving this problem.

Annotations related to sentiment are included. Sentiment analysis is a powerful tool that augments understanding over a wide variety of news from markets and politics to consumer products. We also use a coreference resolution engine to find words or phrases in a text that refer to the same real-world entity. By doing this, main ideas and key concepts are highlighted and tracked throughout the duration of the article. Both of these annotations can be generated using the CoreNLP toolkit. Finally, we include fact-checking using WikiCheck. This is a model that performs a fact validation process using the entire Wikipedia corpus as its knowledge base. Given a claim, WikiCheck will determine whether outside evidence supports or refutes that claim. A summary of the pipeline is shown in FIG. 12.

### Output/Annotated Article

The annotations generated from the pipeline of FIG. 12 are grouped into four different categories: (1) Chart Similarity, (2) Main Ideas, (3) Sentiment Analysis, (4) Fact Check. These options can be displayed at the top of the news articles as clickable buttons (see FIG. 11). Selecting one of these choices can annotate the article with that type of annotation. Relevant words and sentences are highlighted in various colors. Mousing over and clicking on those highlighted sentences can bring additional tooltips or modal screens with additional information.

Chart Similarity: Using the embedding information from the chart summary and the article text, we can select the top-k most similar sentences using cosine similarity as described herein. For our purposes, we selected k=3. However, the best k can vary from task to task. Setting a k too high could mean that the model will find irrelevant sentences. Instead of fixing a value for k, it was also considered to choose a threshold cosine similarity value. However, the results were varied and unpredictable. The model that can be used, BERT, was not specifically trained on discerning the semantic similarities or differences of sentences. Moreover, there exist many types of news topics (e.g., business, politics, sports), and these variations create inconsistences across topics. Since news in the wild can reference the chart in different ways (e.g., describe a trend, highlight a prominent feature, summarize the entire dataset), we account for the variance by just notifying the reader that a particular sentence is likely related to the chart.

Main Ideas: Using CoreNLP's co-reference engine, the framework 1001 can track entities throughout the article. Consider the sentence “I gave my friend a gift because he was celebrating his birthday.” The co-reference engine is able to discern that “my friend” and “he” are referring to the same entity. Additionally, the first mention of an entity is known as a representative mention, while any subsequent mentions are not. Although this is just a simple demonstrative example, CoreNLP is capable of resolving references such as names, places, dates, and ideas across multiple paragraphs. Categorical colors can be used to highlight references to the same entity and use mouseover tooltips to guide the reader.

Sentiment Analysis: CoreNLP also has an engine for analyzing the sentiment of a sentence. The model was trained on the Stanford Sentiment Treebank dataset which improves on previous methods by not just analyzing words in isolation but how they are combined. For example, the model is able to learn that funny and witty convey positive sentiments, but form an overall negative thought when used in the sentence “This movie was actually neither that funny, nor super witty.”

Fact Check: Finally, WikiCheck can be integrated into the framework 1001 as part of an annotation tool for fact-checking claims. Given a claim, WikiCheck identifies whether said claim is supported or refuted by evidence in the knowledge base consisting of all Wikipedia pages. In other cases, there will not be enough information to make a decision. Because the knowledge base is vast, a query-enhancing step must be performed to reduce the number of Wikipedia pages searched; otherwise, the computation time would be too prohibitive. After getting a list of candidate articles, a natural language inference (NLI) model is applied to the claim and the evidence. NLI is primarily focused on determining the relationship between text fragments. We set the claim as the hypothesis and the text in the candidate articles as text. Then we apply NLI:
If the text entails the hypothesis, then the claim is likely to be true. We say that the claim is SUPPORTED by evidence from outside sources.
If the text contradicts the hypothesis, then the claim is likely to be false. We say that the claim is REFUTED by evidence from outside sources.
If the text neither entails nor contradicts the hypothesis, then there is not enough information to make a decision. We say that there is NOT ENOUGH INFORMATION to support or refute this claim.

### Case Studies

In this section, we present the results of our annotation tool (1024) on two articles taken from the Economist.

### Case 1: Cryptocurrency Article

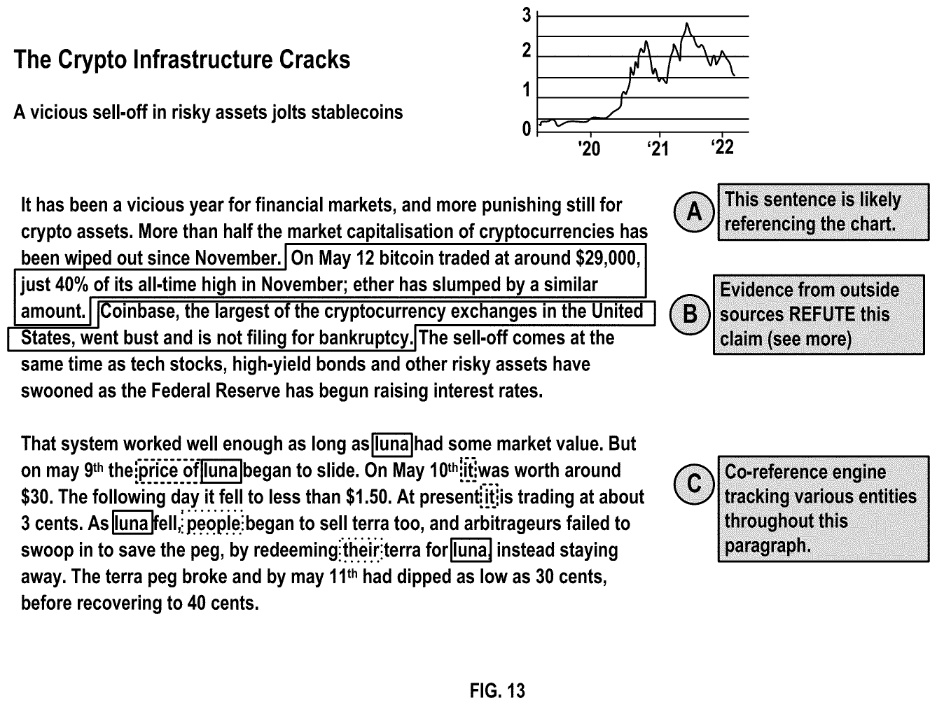

The first article (FIG. 13), entitled “The Crypto Infrastructure Cracks,” describes the sell-off in cryptocurrencies such as Bitcoin and Ether in the middle of 2022, causing prices of all cryptos to decline rapidly. In FIG. 13, sample output of various sections of Case 1 are shown. Chart linking is shown in green. Fact-checking is shown in yellow. The bottom paragraph illustrates the coreference functionality, which recognizes the same entity by color coding them.

The article of FIG. 13 introduces stablecoins, which are cryptocurrencies that are backed by another currency, such as the US dollar. They act as a bridge between conventional banks, where people use fiat money, and the crypto-world, where people use cryptocurrencies. In theory, they should be more stable than cryptocurrencies since each stablecoin has a mechanism to maintain its price. Terra, a stablecoin was backed by another cryptocurrency, Luna. As Luna started to rapidly decline, Terra also joined in the downward spiral, resulting in a more than tenfold reduction in value. Not all stablecoins experience as dramatic of a downfall as Terra, but the Terra-Luna disaster calls into question the infrastructure of the cryptocurrency economy.

The Economist is generally an in-depth, reputable source with no heavy or extreme partisan bias. However, there may still exist wrong information due to inaccuracies in reporting. Usually when this happens, the editors are quick to catch it and correct it swiftly. However, in order to showcase how our tool handles potentially false information, we modify our articles to trigger the fact-checker in our tool. In one location in the article, we inserted the claim “Coinbase, the largest of the cryptocurrency exchanges in the United States, went bust and is now filing for bankruptcy.” This is false information, as Coinbase never filed for bankruptcy nor did they announce any plans to do so. The implications of such a claim are huge, as it is a publicly traded company. This potentially false news can misinform investors, causing huge swings in the prices. We also inserted the sentences “USD coin, is pegged to the US Dollar. Therefore, USD coin will always be worth one dollar.” This is also false information, as USD coin is worth approximately one dollar, and it is not always equivalent to a dollar. Similarly, the consequences of including false information are also serious, as they can translate to large monetary losses if a reader chooses to take action on this information.

In the publication, a line chart plots the market value of cryptocurrencies from 2020 to 2022. It details a meteoric rise to an all-time high of nearly $3 trillion US dollars in the middle of 2021. Then, the chart shows a steady fall to about half of its all-time-high price. The BERT model chooses to link the sentence “On May 12th bitcoin traded at around $29,000, just 40% of its all-time high in November; ether has slumped by a similar amount.” with the chart (see (A) in FIG. 13). Upon a closer inspection, this sentence is most related to the chart, as it is the only sentence that describes the events portrayed in the chart; no other passage from the article does so. Another sentence was also identified as related to the chart: “A week ago, when Luna was trading at $85 a piece, that meant a Terra holder could redeem it for 0.0118 Lunas.” However, this is not the best annotation, as this passage does not intersect with the chart. Because the chart-linking functionality works by selecting the top-results, lowering the value can help reduce irrelevant sentences. However, this would introduce unnecessary complexity to the audience.

### Case 2: Immigration Article

The second article “A Shortfall in Immigration has Become an Economic Problem for America” explains the slowing of immigration and its negative impact on many sectors and industries in the American economy. The COVID-19 pandemic contributed the most to the decrease in net international migration as America banned international visitors from dozens of countries and froze immigration applications. The consequences can be seen by employers in many sectors: restaurant, accommodation, business services, and technology struggled to fill vacancies or find competitive talent. However, the author states that immigration reform is a daunting task, requiring ten votes from Republican senators for a bill to pass legislation. The article ends on a hopeful note, and the author offers some of his or her own suggestions to restore immigration numbers.

In this article, we inject two false claims about immigration. We insert the sentence “Even though immigrants make up a sizeable portion of the US economy, their contribution is a measly 0.23% of GDP; thus, the slight decline in immigration is hardly measurable.” The original article states that new immigrants were responsible for nearly 70% of growth in the American labor force in the 2010s. We change 70% to “only 10%.” In this case, both claims were flagged as likely false information, and the WikiCheck pipeline presented multiple pieces of evidence to refute each claim (see (D) in FIG. 11).

The data visualization that accompanies this article is a line chart that shows the number of foreign-born workers in the American workforce from 2010 to 2022. In 2010, there were roughly 32 million foreign workers, and that number linearly increased until 2019, when there were about 38 million workers. However, after 2019, the data deviates from the linear trend and decreases moderately before recovering to the same figure in 2019. A dotted line shows the pre-2019 trend, which suggests that if immigration stayed on course, there would be roughly 2 million more immigrant workers. This is a multi-series data visualization (one for the actual trend, and one for the projected trend). Although the chart-to-text linking pipeline supports multi-series and multivariate data, the chart-to-data reader only was only able to process the actual trend, omitting the 2010-2019 projected trend. The chart similarity annotation engine still was able to link the correct sentence to the chart; it singles out “Giovanni Peri and Reem Zaiour of the University of California, Davis, estimate that by February America was missing roughly 1.8 m working-age foreign migrants relative to its post-2010 trend (see chart).” as being related to the chart, where the article makes an explicit mention to the chart. Even after deleting the “(see chart)” cue, the model still links to the same sentence.

The Main Ideas and Sentiment Analysis serve as supplementary annotations that enrich a reader's experience ((B) and (C) of FIG. 11).

### Experiment

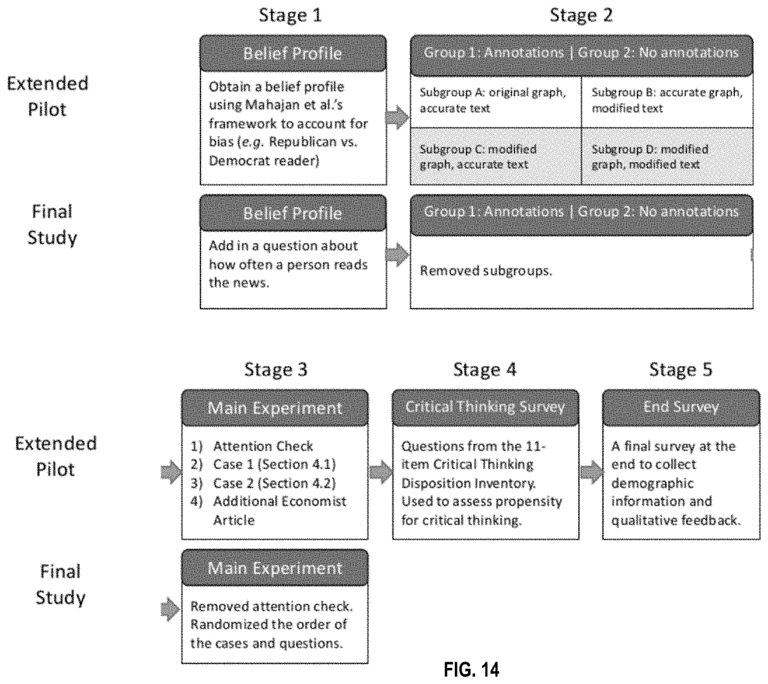

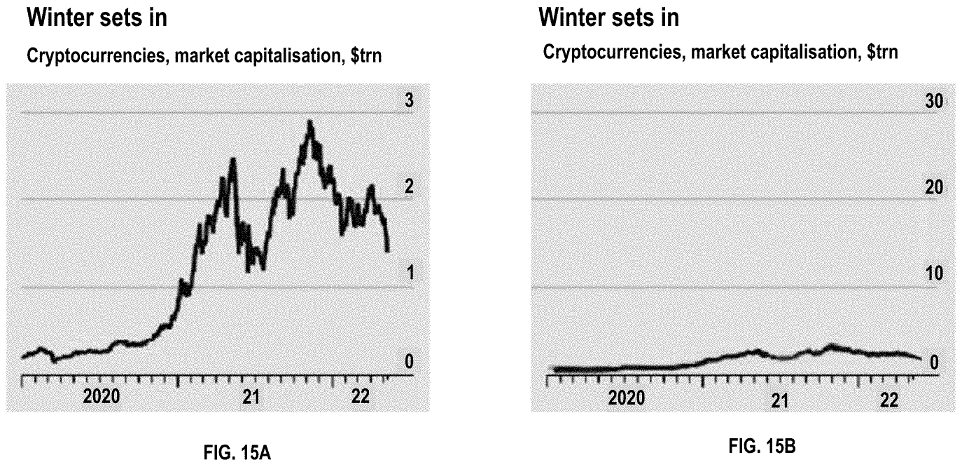

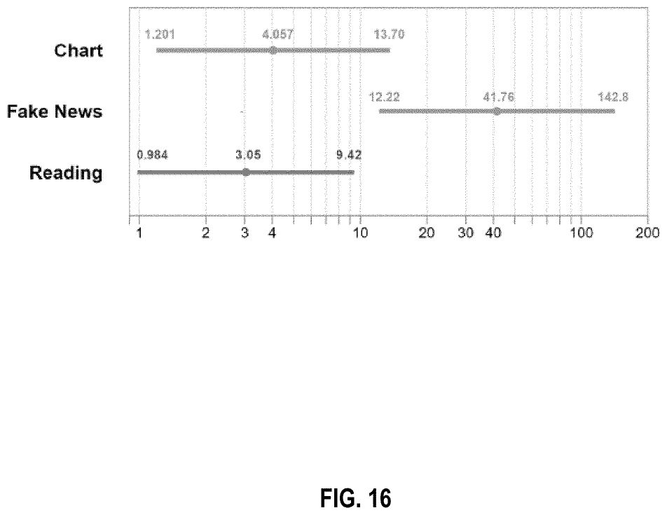

In addition to our case studies, we conduct a crowdsourced experiment to analyze critical thinking and susceptibility to potentially deceptive news. The study is summarized in FIG. 14 which shows a design of the experiment. In the stage 2 of the extended pilot, participants are assigned to two possible groups with each group having four subgroups. This effectively creates 8 unique treatments for a between-subjects design. The final study was revised according to the results in the extended pilot. FIG. 15 shows an example of an inaccurate graph used in our study. Based on relevant literature, graphs like this obscure the intended information and convey an entirely different message.

### Study Design (Extended Pilot)

One of the most important aspects is to select the right articles. Research has shown that readers sometimes become apprehensive when presented with information not in line with their beliefs. Most of these come from politically polarizing or controversial topics. As such, we present our participants with matter-of-fact topics to avoid the interference of individual bias in our results. Although we cannot completely eliminate bias, we choose to ask readers about their personal beliefs in order to assess differences in regards to pre-formed opinions. We use a framework inspired by Mahajan et al. to elicit a belief profile before showing participants the data and the news.

We measure reader engagement by writing 4 reading comprehension questions. We split participants into Group 1 and Group 2 in order to assess this difference. Participants from Group 1 read the article with the assistance of our annotation tool, while participants from Group 2 read a static article without interactive annotations.

Moreover, we are interested in how combinations of potentially deceptive visualizations or text can influence a reader as well as if our tool can help reverse some of its effects. Thus, we split each group into four subgroups: Subgroup A: original article, original graph, Subgroup B: modified article, original graph, Subgroup C: original article, modified graph, Subgroup D: modified article, modified graph. Therefore, there will be eight (8) unique treatments: Group 1A, Group 1B, Group 1C, Group 1D, Group 2A, Group 2B, Group 2C, Group 2D. We run these as a between-subjects design. We modified the text by inserting exactly two false claims (as described in the Case Studies above), maintaining that these injected false claims do not change the answers to the questions. We increased the scale of the y-axes in the original visualizations by a factor of 7-10. Thus, an increase in the line chart now appears 7-10 times smaller (see FIG. 15). Modified text and charts can have different effect sizes on the reader, so we wrote two questions asking “how much” or “to what extent” on a Likert scale. As these have no ground truth answers, variations in responses can be attributed to how the charts can sway a reader's opinion.

At the conclusion of the main experiment, we conduct a critical thinking disposition survey, which measures a person's propensity for critical thinking. This 11-item survey was developed and evaluated for factorial validity by Sosu. The last survey is a demographic survey for more additional analyses as needed. In order to explore potential research methods and account for unforeseen issues, we run the first batch as an extended pilot.

### Hypotheses (Extended Pilot)

H1: Readers from Group 1 will score higher in the critical reading questions (Questions 1-4 of each case) than those from Group 2. We hypothesize that readers will engage with the tool and spend more time reading, resulting in more retained knowledge and information.

H2: There will be a difference in subgroups A, B, C, D of Group 1 and Group 2 in Questions 5-6. We believe that the use of modified visualizations and text may sway a reader's understanding, as confirmed by previous studies.

H3: The effects of H2 are greater in Group 2 and Group 1. Since the annotation tool has the ability to point out potentially false claims and stimulate critical thinking, readers may be less susceptible to potential deception. Fan et al. ran a similar study where participants who saw deceptive visualizations with an annotation tool were less susceptible to the deceptive tactics used in charts.

### Quantitative Results (Extended Pilot)

We ran a pilot study using the design setup with 250 participants, where each participant was assigned to one of 8 groups (between-subjects design, factorial combinations of GROUP, TEXT ACCURACY, and CHART ACCURACY). The quantitative analyses performed for the extended pilot and final study data both follow a general procedure called Generalized Linear Mixed Modeling (GLMM), a flexible class of statistical models that accommodates different response types (normal, binary), multiple factors and their interactions, and more importantly, complex error systems due to the presence of factors that have the potential to have their own random variation (random effects). Statistical results were generated using the PROC GLIMMIX procedure in SAS 9.4.

For brevity, we do not show the statistical details here, but the modeling procedure yielded inconclusive results due to none of the expected effects (including interactions) being statistically significant at the 5% level. None of the hypotheses H1, H2, H3 were supported. This result was unexpected, specially for the comparisons between the group with annotation and the group without. We believe that this could not have been an issue of inadequate sample size, so we focused our attention to the quiz questions to check if this was an issue of a lack of internal validity i.e., are these questions measuring what they are supposed to be measuring?

In the modeling procedure, Questions were treated as random effects nested within Case, which in turn was nested within Subjects (participants). This allowed for an error structure that estimates an association among answers within a participant. From the estimated variance-covariance matrix of a participant's propensity to get an answer correct, we noticed that the variances and their standard errors for each question were overinflated, suggesting that for each question and experimental group, there wasn't enough variation in correct answers. In turn, this implies that the questions themselves were most likely inadequate to distinguish between the effects of the annotation tool (1024) and the differences among the participants' abilities.

For this reason, we opted for two strategies in the next set of experiments: first, we analyzed each question using a test measurement technique called item analysis, which would show which questions are potentially problematic in terms of difficulty and level of discrimination among participants' abilities. The discrimination value indicates how well a question item distinguishes people who scored high and people who scored low. Typically, a higher positive value is desired, as it is a strong indicator of a question to differentiate between high and low skilled test takers. Second, we revisited the construct of testing the annotation tool for the skill measures that were relevant to the tool itself. As an example, we decided to reformulate certain questions so that they were directly measuring the utility of our annotation tool (1024).

### Qualitative Results (Extended Pilot)

Even though the analysis from the Extended Pilot Study did not yield any conclusive results, we summarize the qualitative feedback from our participants from Group 1 to gain insight into the human factors of our work. Feedback was overwhelmingly positive. 8% of the participants (10/125) had negative feedback, and they provided responses just out of personal preference “Honestly, I didn't like it.” (P186) “Did not find this tool helpful” (P191). On the other hand, most of them provided one-liner statements about a positive attribute of the tool that they used. Out of the many positive comments, one of the praised features was the fact check. 20 participants singled it out as one of the most interesting features. One participant said “I really like the idea of being able to fact-check with two clicks.” (P98). Another participant said “Somehow I didn't notice the fact check tool till the end. When I was on the last article and the realized how many points were false that was surprising and I thought about how many points on the prior articles were false that i missed. So even though I saw it late. I like the fact check button.” (P249). Finally, another one said “I like the fact checker. Seemed hard to apply as not sure if I should answer questions based upon what was in the article or the fact checker, so I used the article's/graphs data.” (P242) Since the fact check claims were automatically generated, and the questions we wrote were not necessarily written with the fact check tool in mind, this response was expected.

However, automatic fact-checking is still not perfect. Participant 98 found that sometimes “info from the fact checking tool seemed unrelated, or only very vaguely related. I stopped using it because of that.” This is due to the fact that in real-world articles, many sentences are transition sentences and do not necessarily put forth a claim. Journalists use analogies, hyperbole, and other rhetorical devices that are not meant to be taken literally. In our tool, every sentence was a claim. Thus, future work can focus on filtering out individualized and unimportant sentences.

Certain participants also found the tool helpful for answering questions. We surmised that that the coreference engine was responsible for this. Participant 116 said “I mainly liked the Main Idea annotation tool. It pointed out some things that helped with answering some of the questions.” Other participants also said that the entire annotation tool helped them with answers, although they did not specifically mention the main ideas tab. Additionally, one participant liked the main ideas tab without mentioning the reading questions: “It highlighted key points in each article if I struggled to find them myself.” (P14). In a real-world setting, questions do not accompany an article, and this shows that the coreference engine is helpful even in the absence of a quiz.

We received a suggestion on accessibility as well. Since news and data visualizations are primarily visual, people who may not be visual learners may encounter difficulties. Participant 181 made it clear that she was an auditory learner and suggested that listening to it can be a functionality. “I would make it so I could listen to it because I'm an auditory learner.” She later said “I am not a visual learner so the annotation tool helped me focus on parts of the article and arguments.” These are helpful takeaways and can help drive the design of future iterations of our tool.

### Study Design (Final Study)

Since there were no significant findings between subgroups A, B, C and D, we removed those subgroups. We only use two groups: Group 1 (with annotations), and Group 2 (without annotations). Based on the item analysis, we only kept three (3) questions for each case that had a valid or positive discrimination value. We wrote a question about each of the two (2) false claims in the article and one (1) about linking the article text to the chart for a total of six questions. We randomized the order of the cases shown as well as the sequence of the 6 questions for each case. Finally, we also recorded the time spent on each question.

We were also interested in other factors that might create skill differences in critical reading, fake news identification, and data chart linking. Thus, we asked participants how often they read the news: (1) Once a month or less; (2) Once a week; (3) A few times a week; (4) Daily. This was introduced into our experiment as a separated variable named READING FREQUENCY.

### Hypotheses (Final Study)

H1: Due to the helpful effects of our annotation tool. Group 1 will score higher on critical reading, fake news, and chart linking questions than Group 2

H2: Group 1 participants spend less time on fake news and chart linking questions. Our annotation tool has dedicated tabs for these types of questions. The difference will be less pronounced for critical reading questions.

H3: Education level and how often a person reads the news have little or no effect on how well a participant identifies fake news. This is in line with previous research that shows that critical thinking or variants of critical thinking skills are traits that make a person least susceptible to fake news. Education, gender, and other characteristics have weak or no effect.

### Quantitative Results (Final Study)

In general, the study redesign resulted in improved metrics for the item analysis measures. For the extended pilot and the final study, the average discrimination indices across questions were respectively 2.69 and 7.06, suggesting that the questions or tasks in the final study better distinguished among participants with different abilities (participants who tended to do well overall tended to answer specific questions correctly). Additionally, in contrast to the extended pilot, the final study yielded better model diagnostics (estimated variances and other statistical measures) and results also supported the study hypotheses. Finally, we note that we report the results on two models: (1) the initial model, which contains a GLMM with all predictors of interest, including interactions; and (2) the final model, which is a reduced GLMM, discarding non-significance predictors at the 5% significance level. A summary of all of the p-values are in Table 4.

TABLE 4: Results of the Final Study.

| | | | | | H3: Correct vs. | |
|---|---|---|---|---|---|---|
| | H1: Correct vs. Incorrect | | H2: Log Time | | Incorrect (Fake News) | |
| | | Final | Initial | Final | Initial | Final |
| Fixed Effect | Model | Model | Model | Model | Model | Model |
| GROUP | p < 0.05 | p = 0.0004 | p = 0.1297 | p = 0.1297 | p = 0.0025 | p < 0.0001 |
| QUESTION TYPE | p < 0.05 | p = 0.0568 | p = 0.0242 | p = 0.0242 | x | x |
| GROUP × QUESTION TYPE | p < 0.05 | p < 0.0001 | p < 0.0001 | p < 0.0001 | x | x |
| READING FREQUENCY | p > 0.05 | p = 0.2869 | x | x | p = 0.5019 | ∘ |
| GROUP × READING FREQUENCY | p > 0.05 | p = 0.0543 | x | x | p = 0.4121 | ∘ |
| EDUCATION | p > 0.25 | ∘ | x | x | p = 0.8077 | ∘ |
| GROUP × EDUCATION | p > 0.25 | ∘ | x | x | p = 0.4069 | ∘ |
| GENDER | x | ∘ | x | x | p = 0.6187 | ∘ |
| GROUP × GENDER | x | ∘ | x | x | p = 0.7795 | ∘ |

x: not of interest
∘: discarded due to statistical non-significance

H1: For this hypothesis, we fit a GLMM with GROUP, QUESTION TYPE (this variable indicates if a question is reading, fake news, or chart-related), and the interaction effect between the two (GROUP×QUESTION TYPE) as the fixed effects. The significance of the interaction effect at the 5% level would prove or disprove if there are differences between the GROUP with annotation and without, with respect to the probability of getting a correct answer, and whether this impact is dependent on QUESTION TYPE. We also included EDUCATION, READING FREQUENCY, and their interactions with GROUP to test and when necessary, adjust for the effects of these covariates.

The final model resulted in a significant GROUP×QUESTION TYPE interaction effect (p<0.0001) and a non-significant EDUCATION×GROUP interaction. Another interaction effect of interest, READING FREQUENCY×GROUP effect yielded a p-value of p=0.0543, which is strictly non-significant but may be an indicator of a potential effect, so it stayed in the final model as an adjustment in the conditional effects of GROUP×QUESTION TYPE. The significant impact of the GROUP×QUESTION TYPE interaction implies that the impact of annotations on the probability of getting an answer correct depends on the QUESTION TYPE i.e., whether the question is critical reading, fake news, or chart-related. Estimation of the differences in the log-odds odds ratio (see FIG. 6) between the two groups for each QUESTION TYPE results in the confirmation of the hypothesis that the group with annotations tended to answer a fake news-related question correctly 41×more likely than the group without annotations (p<0.0001), while correctly answering chart-related questions 4×more frequently (p=0.0243). Annotations do not seem to produce a verifiable impact for critical reading-type questions (p=0.0523).

H2: It is also of interest to check if the annotation tool significantly decreases the time it takes to answer fake news and chart-related questions. To confirm this hypothesis, we transformed Time (time to answer a question in seconds) using the natural log transformation to approximate normally distributed errors. Subsequently, a GLMM was fitted with GROUP, QUESTION TYPE, and GROUP×QUESTION TYPE as predictors. Table A shows similar results to H1 where the response (LN TIME) is significantly impacted by the GROUP×QUESTION TYPE interaction effect (p<0.0001), again implying that the effect of the annotations on the response is dependent on the QUESTION TYPE. Further estimation of the differences between groups with and without the annotation tool results in fake news-related questions posting a significant decrease in processing time (p=0.0003), while chart and critical reading-related questions did not show a significant improvement. The modeling procedure provides an estimate of 0.6423 for the exponentiated difference between the groups with and without annotations, suggesting that the group with the tool took approximately half the time to answer a fake news question than the group without the tool. For the 6 fake news-related questions, it took the participants from the annotation group around 47 seconds on the average to answer a question, while the non-annotation group took around 81 seconds on the average.

H3: We perform a similar analysis and modeling process as in H1, but included additional covariates (EDUCATION, GENDER and their interactions with GROUP) and focused only on fake news related questions. Results shown in Table 4 confirm the hypothesis that the effect of the annotation tool is not dependent on specific participant attributes that were previously demonstrated to have little or weak effect. None of the covariates' interaction with the GROUP variable yielded significant results at the 5% level. Further, the GROUP predictor is significant as expected (p<0.01), suggesting that while the tool assists in correctly answering fake news questions, the tool's positive effect seems to be agnostic with respect to a participant's educational level, gender, and the frequency by which they read news.

### Conclusion

In this paper, we present and develop an interactive annotation tool designed to combat potential misinformation and boost reading engagement. The tool reads text and chart data and automatically generates tem plated annotations. Through a human subjects study, we confirm that participants can detect fake news faster and more accurately with the assistance of our tool. We split participants into Group 1 (participants who used our interactive annotation tool), and Group 2 (participants who read a static article). In Group 1, participants were 41 times more likely to answer a question about fake news correctly when compared to participants in Group 2. Additionally, they were also roughly 1.5 times faster at doing so. In Group 1, participants were 4 times more likely to find relevant passages in the article that relate to the visualizations, thus reinforcing their understanding of the story with data. The implications of such a result are promising, as it indicates that our annotation tool is effective at detecting potentially fake news automatically and conveying it clearly to the audience. Finally, additional analyses confirmed that a reader's education level and how frequently he or she reads the news has no significant impact on the ability to detect fake news.

Limitations In this paper, we argued that automatic fact-checking is more scalable than manual expert-based fact-checking without sacrificing effectiveness. However, we note two limitations. First, background processing time is one major bottleneck. It takes 3 minutes 12 seconds to generate the annotations used in Case 1 (Section 4.1) on a system running on an Intel i7-12700 CPU. Second, while the effectiveness of fact checking was demonstrated through our study, participants pointed out that sometimes the evidence displayed was tangential to the main topic. This is due to the fact that not every sentence in an article is meant to be fact check. Transition sentences, interjections, and author commentary are not strictly factual. When a fact-checking attempt is made on those claims, it may result in irrelevant or unpredictable results. Addressing this problem will result in more pertinent information being displayed. One such approach is to filter out non-factual claims, which can speed up the processing stage as well.

Our fact-checking is based on Wikipedia, an online encyclopedia that usually has high accuracy and coverage. However, since it is a source that can be edited by anyone at any time, the validity of the facts may not be perfect. Also, Wikipedia itself is prone to partisan, gender, and cultural biases as well. People who hold beliefs that are not in line with the bias may be reluctant to agree with the evidence.

The other technique we introduce is linking chart to text. While we also demonstrated its effectiveness and showed that it helps in reading comprehension and information retention, the functionality remains limited. Simply linking the chart to a particular excerpt in the article may be helpful but more advanced techniques would better enrich the data exploration process. For example, Latif et al. propose a framework for creating interactive webpages that support visual highlighting, details on demand, and bushing-and-linking. Whereas in our framework, a passage is connected to the chart, in their framework, individual words and ideas are connected to different locations in the chart. Capturing finer detail and information is something that we considered but constrained by current NLP methods. We anticipate with the development of more advanced NLP and computer vision models, finer grain detail can be achieved when linking chart to text.

Future Work Data visualization and reading online news is a primarily visual endeavor. People who may not be visually inclined may find difficulties in understanding online news. One of our study participants, who is primarily an auditory learner, found that the highlighting key parts of the article can assist in extracting the key ideas and arguments. Future work can investigate dedicated methods to make data and online news more accessible and accurate to those that are less visually inclined.

For the chart linking functionality, we mainly studied its effects on univariate line charts. As discussed earlier, more complex interactions and in-depth annotations can be generated for charts. We also plan to extend text to chart linking for more varied and advanced datasets such as bar charts, choropleth maps, and multivariate data. Battle et al. crawled 20 million webpages and found that maps, line charts, and bar charts were the most popular chart types found on the internet.

While our tool did not significantly improve scores on the reading comprehension questions, future work can explore specifically designing interactions and annotations for improving reading skill and general education. Building mental pictures of ideas while reading is an efficient strategy in language learning. Erfani et al. find that including visualization strategies significantly improved reading comprehension skills in university students. Another study reiterates the necessity for methods for improving reading comprehension, citing that a lack of reading proficiency in children can cause difficulties in employment, social functioning, and other daily aspects of living. One of the most effective methods is to use visualization methods to help build a mental image of text.

### Computer-Implemented Device

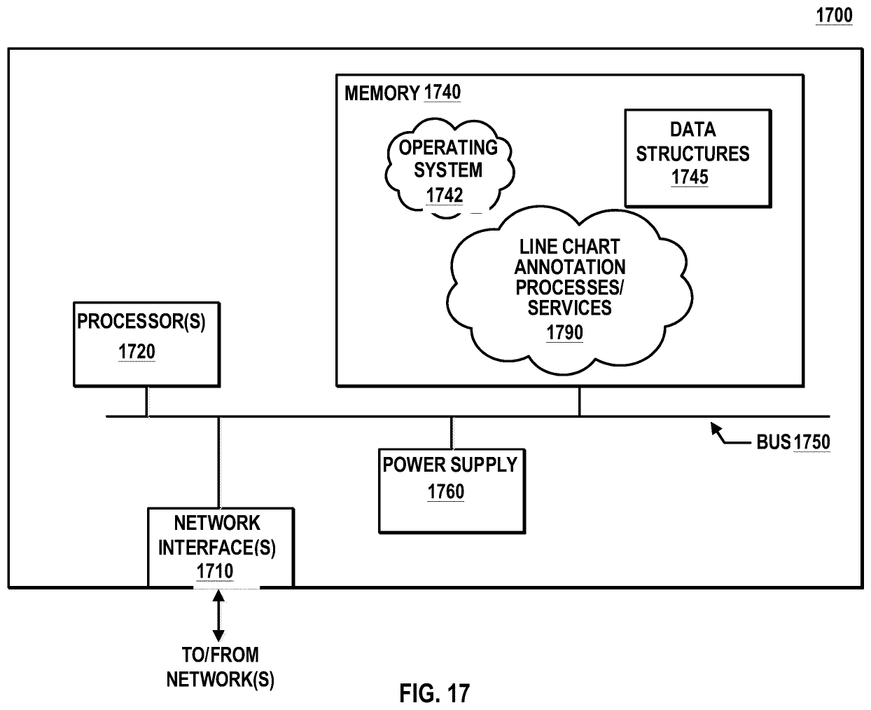

FIG. 17 is a schematic block diagram of an example device 1700 that may be used with one or more embodiments described herein, e.g., as a component of framework 100 shown in FIG. 2A and/or framework 1001.

Device 1700 comprises one or more network interfaces 1710 (e.g., wired, wireless, PLC, etc.), at least one processor 1720, and a memory 1740 interconnected by a system bus 1750, as well as a power supply 1760 (e.g., battery, plug-in, etc.).

Network interface(s) 1710 include the mechanical, electrical, and signaling circuitry for communicating data over the communication links coupled to a communication network. Network interfaces 1710 are configured to transmit and/or receive data using a variety of different communication protocols. As illustrated, the box representing network interfaces 1710 is shown for simplicity, and it is appreciated that such interfaces may represent different types of network connections such as wireless and wired (physical) connections. Network interfaces 1710 are shown separately from power supply 1760, however it is appreciated that the interfaces that support PLC protocols may communicate through power supply 1760 and/or may be an integral component coupled to power supply 1770.

Memory 1740 includes a plurality of storage locations that are addressable by processor 1720 and network interfaces 1710 for storing software programs and data structures associated with the embodiments described herein. In some embodiments, device 1700 may have limited memory or no memory (e.g., no memory for storage other than for programs/processes operating on the device and associated caches).

Processor 1720 comprises hardware elements or logic adapted to execute the software programs (e.g., instructions) and manipulate data structures 1745. An operating system 1742, portions of which are typically resident in memory 1740 and executed by the processor, functionally organizes device 1700 by, inter alia, invoking operations in support of software processes and/or services executing on the device. These software processes and/or services may include line chart annotation processes/services 1790 described herein. Note that while line chart annotation processes/services 1790 is illustrated in centralized memory 1740, alternative embodiments provide for the process to be operated within the network interfaces 1710, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the line chart annotation processes/services 1790 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system for annotating line charts in the wild, comprising:
processor in communication with a memory, the memory including instructions, which, when executed, cause the processor to:
receive an image featuring a graphical representation;
extract a plurality of features from the image featuring the graphical representation;
compare the plurality of features to a plurality of accepted guidelines for graphical representations; and
output an assessment of the image featuring the graphical representation.

2. The system of claim 1, wherein the memory includes instructions, which, when executed, further cause the processor to:
generate a corrected image featuring the graphical representation such that the corrected image conforms to the plurality of accepted guidelines for graphical representations

3. The system of claim 1, wherein the plurality of accepted guidelines for graphical representations include guidelines for:
truncation of a y-axis of a graphical representation;
inversion of the y-axis of the graphical representation; and
an aspect ratio of the graphical representation.

4. The system of claim 1, wherein the memory includes instructions, which, when executed, further cause the processor to:
extract text and location of the text from the image featuring the graphical representation.

5. The system of claim 1, wherein the memory includes instructions, which, when executed, further cause the processor to:
classify a role of the text extracted from the image featuring the graphical representation

6. The system of claim 1, wherein the memory includes instructions, which, when executed, further cause the processor to:
select an aspect ratio for the image featuring the graphical representation such that an average of all line segments within the graphical representation is 45°.

7. The system of claim 6, wherein the memory includes instructions, which, when executed, further cause the processor to:
calculate an ideal aspect ratio of the image featuring the graphical representation; and
provide an alert if a current aspect ratio deviates from the ideal aspect ratio by a multiplicative factor of log 10(ARlarge/ARsmall)>0.5.

8. A system, comprising:
a processor in communication with a memory, the memory including instructions, which, when executed, cause the processor to:
extract input information from an article that includes data visualization and text, wherein text elements of the data visualization are extracted and predetermined text parameters are extracted from the text of the article;
conduct analysis of the input information to generate a summary of the data visualization which serves as a latent text representation of the data visualization and calculate semantic similarities between the latent text representation and each sentence in the text of the article itself; and
generate, using output of the the analysis of the input information, one or more annotations for the article based on a selected annotation category.

9. The system of claim 8, wherein the processor executes a natural language processing (NLP) model to calculate the semantic similarities.

10. The system of claim 8, wherein the predetermined text parameters include an article headline, and a date of publication for the article.

11. The system of claim 8, wherein the data visualization is a chart.

12. The system of claim 11, wherein the memory includes further instructions, which, when executed, cause the processor to:
generate an embedding e_{chart} for the summary and then an embedding for all of the sentences eᵢ, where i is the index of the sentence, and
find a most similar sentence by calculating a cosine distance between the embeddings.
